(19) United States
(12) Patent Application Publication
(10) Pub. No.: US 2022/0012307 A1
(43) Pub. Date: Jan. 13, 2022

(54) INFORMATION PROCESSING DEVICE, INFORMATION PROCESSING SYSTEM, INFORMATION PROCESSING METHOD, AND STORAGE MEDIUM

(71) Applicants: KABUSHIKI KAISHA TOSHIBA, Tokyo (JP); TOSHIBA DIGITAL SOLUTIONS CORPORATION, Kawasaki-shi (JP)

(72) Inventors: Masaru SUZUKI, Tokyo (JP); Hayato GOTO, Kawasaki (JP); Kosuke TATSUMURA, Kawasaki (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 17/487,144

(22) Filed: Sep. 28, 2021

Related U.S. Application Data
(63) Continuation of application No. PCT/JP2020/014164, filed on Mar. 27, 2020.

(30) Foreign Application Priority Data
Mar. 28, 2019 (JP) 2019-064588

(51) Int. Cl. G06F 17/16

(52) U.S. Cl. CPC G06F 17/16

(57) ABSTRACT

An information processing device includes a storage unit and a processing circuit, and repeatedly updates a first vector having a first variable as an element and a second vector having a second variable as an element. The processing circuit updates the first vector by weighted addition of the corresponding second variable to the first variable; stores the updated first vector in the storage unit as a searched vector; performs weighting of the first variable with a first coefficient that monotonically increases depending on the number of updates and adds the weighted first variable to the corresponding second variable; calculates a problem term using the first variables; adds the problem term to the second variable; calculates a correction term including an inverse number of a distance between the first vector to be updated and the searched vector; and adds the correction term to the second variable to update the second vector.

### CROSS REFERENCE TO RELATED APPLICATION

This application is continuation application of International Application No. JP2020/014164, filed on Mar. 27, 2020, which claims priority to Japanese Patent Application No. 2019-064588, filed on Mar. 28, 2019, the entire contents of which are incorporated herein by reference.

### FIELD

Embodiments of the present invention relate to an information processing device, an information processing system, an information processing method, and a storage medium.

### BACKGROUND

A combinatorial optimization problem is a problem of selecting a combination most suitable for a purpose from a plurality of combinations. Mathematically, combinatorial optimization problems are attributed to problems for maximizing functions including a plurality of discrete variables, called “objective functions”, or minimizing the functions. Although combinatorial optimization problems are common problems in various fields including finance, logistics, transport, design, manufacture, and life science, it is not always possible to calculate an optimal solution due to so-called “combinatorial explosion” that the number of combinations increases in exponential orders of a problem size. In addition, it is difficult to even obtain an approximate solution close to the optimal solution in many cases.

Development of a technique for calculating a solution for the combinatorial optimization problem within a practical time is required in order to solve problems in each field and promote social innovation and progress in science and technology.

### BRIEF DESCRIPTION OF DRAWINGS

FIG. 1 is a diagram illustrating a configuration example of an information processing system.

FIG. 2 is a block diagram illustrating a configuration example of a management server.

FIG. 3 is a diagram illustrating an example of data stored in a storage unit of the management server.

FIG. 4 is a block diagram illustrating a configuration example of a calculation server.

FIG. 5 is a diagram illustrating an example of data stored in a storage of the calculation server.

FIG. 6 is a flowchart illustrating an example of processing in a case where a solution of a simulated bifurcation algorithm is calculated by time evolution.

FIG. 7 is a flowchart illustrating an example of processing in a case where a solution is obtained using an algorithm including a correction term.

FIG. 8 is a flowchart illustrating an example of processing in a case where a solution is efficiently obtained using a first vector calculated by another calculation node.

FIG. 9 is a flowchart illustrating an example of processing in a case where a solution is efficiently obtained by the simulated bifurcation algorithm in a plurality of calculation nodes.

FIG. 10 is a flowchart illustrating the example of processing in the case where the solution is efficiently obtained by the simulated bifurcation algorithm in the plurality of calculation nodes.

FIG. 11 is a diagram conceptually illustrating an example of an information processing system including a plurality of calculation nodes.

FIG. 12 is a diagram conceptually illustrating an example of a change in a value of an extended Hamiltonian at each calculation node.

FIG. 13 is a diagram conceptually illustrating an example of the change in the value of the extended Hamiltonian at each calculation node.

FIG. 14 is a diagram conceptually illustrating an example of the change in the value of the extended Hamiltonian at each calculation node.

FIG. 15 is a histogram illustrating the number of calculations required to obtain an optimal solution in a plurality of calculation methods.

FIG. 16 is a diagram schematically illustrating an example of a multi-processor configuration.

FIG. 17 is a diagram schematically illustrating an example of a configuration using a GPU.

FIG. 18 is a flowchart illustrating an example of overall processing executed to solve a combinatorial optimization problem.

### DETAILED DESCRIPTION

According to one embodiment, an information processing device is configured to repeatedly update a first vector which has a first variable as an element and a second vector which has a second variable corresponding to the first variable as an element. The information processing device includes a storage unit and a processing circuit. The processing circuit is configured to update the first vector by weighted addition of the corresponding second variable to the first variable; store the updated first vector in the storage unit as a searched vector; perform weighting of the first variable with a first coefficient that monotonically increases or monotonically decreases depending on the number of updates and add the weighted first variable to the corresponding second variable; calculate a problem term between the first variables; add the problem term to the second variable; read the searched vector from the storage unit; calculate a correction term including an inverse number of a distance between the first vector to be updated and the searched vector; and add the correction term to the second variable to update the second vector.

Hereinafter, embodiments of the present invention will be described with reference to the drawings. In addition, the same components will be denoted by the same reference signs, and a description thereof will be omitted as appropriate.

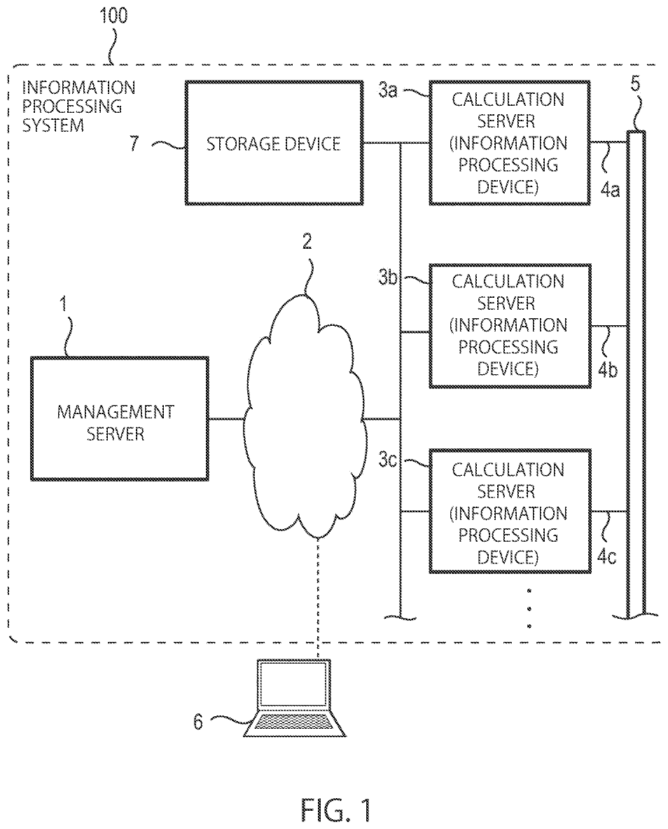

FIG. 1 is a block diagram illustrating a configuration example of an information processing system 100. The information processing system 100 of FIG. 1 includes a management server 1, a network 2, calculation servers (information processing devices) 3a to 3c, cables 4a to 4c, a switch 5, and a storage device 7. In addition, FIG. 1 illustrates a client terminal 6 that can communicate with the information processing system 100. The management server 1, the calculation servers 3a to 3c, the client terminal 6, and the storage device 7 can perform data communication with each other via the network 2. For example, the calculation servers 3a to 3c can store data in the storage device 7 and read data from the storage device 7. The network 2 is, for example, the Internet in which a plurality of computer networks are connected to each other. The network 2 can use a wired or wireless communication medium or a combination thereof. In addition, an example of a communication protocol used in the network 2 is TCP/IP, but a type of communication protocol is not particularly limited.

In addition, the calculation servers 3a to 3c are connected to the switch 5 via the cables 4a to 4c, respectively. The cables 4a to 4c and the switch 5 form interconnection between the calculation servers. The calculation servers 3a to 3c can also perform data communication with each other via the interconnection. The switch 5 is, for example, an Infiniband switch. The cables 4a to 4c are, for example, Infiniband cables. However, a wired LAN switch/cable may be used instead of the Infiniband switch/cable. Communication standards and communication protocols used in the cables 4a to 4c and the switch 5 are not particularly limited. Examples of the client terminal 6 include a notebook PC, a desktop PC, a smartphone, a tablet, and an in-vehicle terminal.

Parallel processing and/or distributed processing can be performed to solve a combinatorial optimization problem. Therefore, the calculation servers 3a to 3c and/or processors of the calculation servers 3a to 3c may share and execute some steps of calculation processes, or may execute similar calculation processes for different variables in parallel. For example, the management server 1 converts a combinatorial optimization problem input by a user into a format that can be processed by each calculation server, and controls the calculation server. Then, the management server 1 acquires calculation results from the respective calculation servers, and converts the aggregated calculation result into a solution of the combinatorial optimization problem. In this manner, the user can obtain the solution to the combinatorial optimization problem. It is assumed that the solution of the combinatorial optimization problem includes an optimal solution and an approximate solution close to the optimal solution.

FIG. 1 illustrates three calculation servers. However, the number of calculation servers included in the information processing system is not limited. In addition, the number of calculation servers used for solving the combinatorial optimization problem is not particularly limited. For example, the information processing system may include one calculation server. In addition, a combinatorial optimization problem may be solved using any one of a plurality of calculation servers included in the information processing system. In addition, the information processing system may include several hundred or more calculation servers. The calculation server may be a server installed in a data center or a desktop PC installed in an office. In addition, the calculation server may be a plurality of types of computers installed at different locations. A type of information processing device used as the calculation server is not particularly limited. For example, the calculation server may be a general-purpose computer, a dedicated electronic circuit, or a combination thereof.

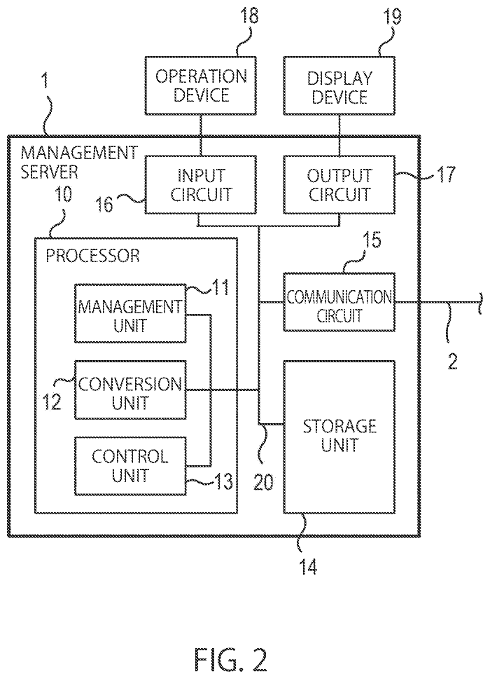

FIG. 2 is a block diagram illustrating a configuration example of the management server 1. The management server 1 of FIG. 2 is, for example, a computer including a central processing unit (CPU) and a memory. The management server 1 includes a processor 10, a storage unit 14, a communication circuit 15, an input circuit 16, and an output circuit 17. It is assumed that the processor 10, the storage unit 14, the communication circuit 15, the input circuit 16, and the output circuit 17 are connected to each other via a bus 20. The processor 10 includes a management unit 11, a conversion unit 12, and a control unit 13 as internal components.

The processor 10 is an electronic circuit that executes an operation and controls the management server 1. The processor 10 is an example of a processing circuit. As the processor 10, for example, a CPU, a microprocessor, an ASIC, an FPGA, a PLD, or a combination thereof can be used. The management unit 11 provides an interface configured to operate the management server 1 via the client terminal 6 of the user. Examples of the interface provided by the management unit 11 include an API, a CLI, and a web page. For example, the user can input information of a combinatorial optimization problem via the management unit 11, and browse and/or download a calculated solution of the combinatorial optimization problem. The conversion unit 12 converts the combinatorial optimization problem into a format that can be processed by each calculation server. The control unit 13 transmits a control command to each calculation server. After the control unit 13 acquires calculation results from the respective calculation servers, the conversion unit 12 aggregates the plurality of calculation results and converts the aggregated result into a solution of the combinatorial optimization problem. In addition, the control unit 13 may designate a processing content to be executed by each calculation server or a processor in each server.

The storage unit 14 stores various types of data including a program of the management server 1, data necessary for execution of the program, and data generated by the program. Here, the program includes both an OS and an application. The storage unit 14 may be a volatile memory, a non-volatile memory, or a combination thereof. Examples of the volatile memory include a DRAM and an SRAM. Examples of the non-volatile memory include a NAND flash memory, a NOR flash memory, a ReRAM, or an MRAM. In addition, a hard disk, an optical disk, a magnetic tape, or an external storage device may be used as the storage unit 14.

The communication circuit 15 transmits and receives data to and from each device connected to the network 2. The communication circuit 15 is, for example, a network interface card (NIC) of a wired LAN. However, the communication circuit 15 may be another type of communication circuit such as a wireless LAN. The input circuit 16 implements data input with respect to the management server 1. It is assumed that the input circuit 16 includes, for example, a USB, PCI-Express, or the like as an external port. In the example of FIG. 2, an operation device 18 is connected to the input circuit 16. The operation device 18 is a device configured to input information to the management server 1. The operation device 18 is, for example, a keyboard, a mouse, a touch panel, a voice recognition device, or the like, but is not limited thereto. The output circuit 17 implements data output from the management server 1. It is assumed that the output circuit 17 includes HDMI, DisplayPort, or the like as an external port. In the example of FIG. 2, the display device 19 is connected to the output circuit 17. Examples of the display device 19 include a liquid crystal display (LCD), an organic electroluminescence (EL) display, and a projector, but are not limited thereto.

An administrator of the management server 1 can perform maintenance of the management server 1 using the operation device 18 and the display device 19. Note that the operation device 18 and the display device 19 may be incorporated in the management server 1. In addition, the operation device 18 and the display device 19 are not necessarily connected to the management server 1. For example, the administrator may perform maintenance of the management server 1 using an information terminal capable of communicating with the network 2.

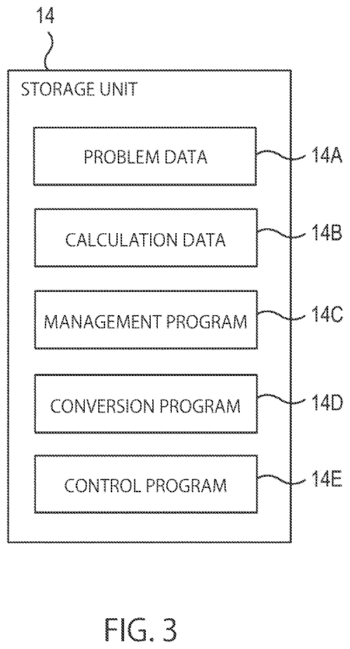

FIG. 3 illustrates an example of data stored in the storage unit 14 of the management server 1. The storage unit 14 of FIG. 3 stores problem data 14A, calculation data 14B, a management program 14C, a conversion program 14D, and a control program 14E. For example, the problem data 14A includes data of a combinatorial optimization problem. For example, the calculation data 14B includes a calculation result collected from each calculation server. For example, the management program 14C is a program that implements the above-described function of the management unit 11. For example, the conversion program 14D is a program that implements the above-described function of the conversion unit 12. For example, the control program 14E is a program that implements the above-described function of the control unit 13.

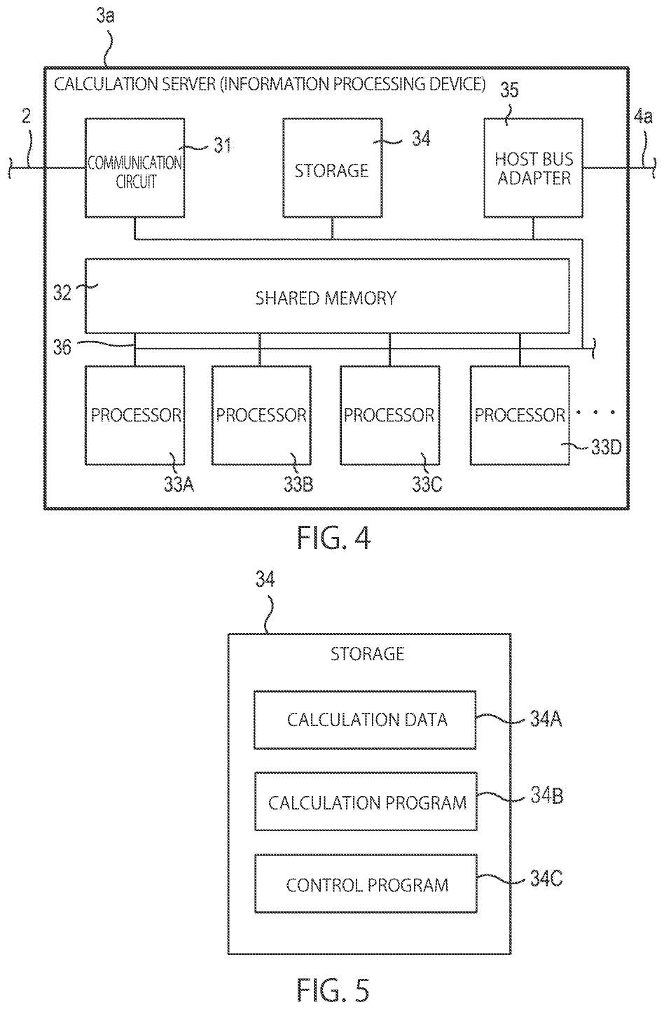

FIG. 4 is a block diagram illustrating a configuration example of the calculation server. The calculation server in FIG. 4 is, for example, an information processing device that calculates a first vector and a second vector alone or in a shared manner with another calculation server.

FIG. 4 illustrates a configuration of the calculation server 3a as an example. The other calculation server may have a configuration similar to that of the calculation server 3a or may have a configuration different from that of the calculation server 3a.

The calculation server 3a includes, for example, a communication circuit 31, a shared memory 32, processors 33A to 33D, a storage 34, and a host bus adapter 35. It is assumed that the communication circuit 31, the shared memory 32, the processors 33A to 33D, the storage 34, and the host bus adapter 35 are connected to each other via a bus 36.

The communication circuit 31 transmits and receives data to and from each device connected to the network 2. The communication circuit 31 is, for example, a network interface card (NIC) of a wired LAN. However, the communication circuit 31 may be another type of communication circuit such as a wireless LAN. The shared memory 32 is a memory accessible from the processors 33A to 33D. Examples of the shared memory 32 include a volatile memory such as a DRAM and an SRAM. However, another type of memory such as a non-volatile memory may be used as the shared memory 32. The shared memory 32 may be configured to store, for example, the first vector and the second vector. The processors 33A to 33D can share data via the shared memory 32. Note that all the memories of the calculation server 3a are not necessarily configured as shared memories. For example, some of the memories of the calculation server 3a may be configured as a local memory that can be accessed only by any processor. Note that the shared memory 32 and the storage 34 to be described later are examples of a storage unit of the information processing device.

The processors 33A to 33D are electronic circuits that execute calculation processes. The processor may be, for example, any of a central processing unit (CPU), a graphics processing unit (GPU), a field-programmable gate array (FPGA), and an application specific integrated circuit (ASIC), or a combination thereof. In addition, the processor may be a CPU core or a CPU thread. When the processor is the CPU, the number of sockets included in the calculation server 3a is not particularly limited. In addition, the processor may be connected to another component of the calculation server 3a via a bus such as PCI express.

In the example of FIG. 4, the calculation server includes four processors. However, the number of processors included in one calculation server may be different from this. For example, the number and/or types of processors implemented on the calculation server may be different. Here, the processor is an example of a processing circuit of the information processing device. The information processing device may include a plurality of processing circuits.

For example, the information processing device is configured to repeatedly update the first vector which has a first variable xᵢ (i=1, 2, . . . , N) as an element and the second vector which has a second variable yᵢ (i=1, 2, . . . , N) corresponding to the first variable as an element.

For example, the processing circuit of the information processing device may be configured to update the first vector by weighted addition of the second variable to the first variable; store the updated first vector in the storage unit as a searched vector; perform weighting of the first variable with a first coefficient that monotonically increases or monotonically decreases depending on the number of updates and add the weighted first variable to the corresponding second variable; calculate a problem term using the plurality of first variables; add the problem term to the second variable; read the searched vector from the storage unit; calculate a correction term including an inverse number of a distance between the first vector to be updated and the searched vector; and add the correction term to the second variable to update the second vector. The problem term may be calculated based on an Ising model. Here, the first variable does not necessarily increase monotonically or decrease monotonically. For example, (1) obtaining a solution (solution vector) of a combinatorial optimization problem when a value of the first coefficient becomes larger than a threshold T₁ (for example, T₁=1), and (2) thereafter, setting the value of the first coefficient to be smaller than a threshold T₂ (for example, T₂=2), then setting the value of the first coefficient to be larger than the threshold T₁ again, and obtaining a solution (solution vector) of the combinatorial optimization problem may be repeated. Note that the problem term may include a many-body interaction. Details of the first coefficient, the problem term, the searched vector, the correction term, the Ising model, and the many-body interaction will be described later.

In the information processing device, for example, a processing content (task) can be allocated in units of processors. However, a unit of a calculation resource in which the processing content is allocated is not limited. For example, the processing content may be allocated in units of calculators, or the processing content may be allocated in units of processes operating on a processor or in units of CPU threads.

Hereinafter, components of the calculation server will be described with reference to FIG. 4 again.

The storage 34 stores various data including a program of the calculation server 3a, data necessary for executing the program, and data generated by the program. Here, the program includes both an OS and an application. The storage 34 may be configured to store, for example, the first vector and the second vector. The storage 34 may be a volatile memory, a non-volatile memory, or a combination thereof. Examples of the volatile memory include a DRAM and an SRAM. Examples of the non-volatile memory include a NAND flash memory, a NOR flash memory, a ReRAM, or an MRAM. In addition, a hard disk, an optical disk, a magnetic tape, or an external storage device may be used as the storage 34.

The host bus adapter 35 implements data communication between the calculation servers. The host bus adapter 35 is connected to the switch 5 via the cable 4a. The host bus adapter 35 is, for example, a host channel adaptor (HCA). The speed of parallel calculation processes can be improved by forming interconnection capable of achieving a high throughput using the host bus adapter 35, the cable 4a, and the switch 5.

FIG. 5 illustrates an example of data stored in the storage of the calculation server. The storage 34 of FIG. 5 stores calculation data 34A, a calculation program 34B, and a control program 34C. The calculation data 34A includes data in the middle of calculation by the calculation server 3a or a calculation result. Note that at least a part of the calculation data 34A may be stored in a different storage hierarchy such as the shared memory 32, a cache of the processor, and a register of the processor. The calculation program 34B is a program that implements a calculation process in each processor and a process of storing data in the shared memory 32 and the storage 34 based on a predetermined algorithm. The control program 34C is a program that controls the calculation server 3a based on a command transmitted from the control unit 13 of the management server 1 and transmits a calculation result of the calculation server 3a to the management server 1.

Next, a technique related to solving a combinatorial optimization problem will be described. An example of the information processing device used to solve the combinatorial optimization problem is an Ising machine. The Ising machine refers to an information processing device that calculates the energy of a ground state of an Ising model. Hitherto, the Ising model has been mainly used as a model of a ferromagnet or a phase transition phenomenon in many cases. In recent years, however, the Ising model has been increasingly used as a model for solving a combinatorial optimization problem. The following Formula (1) represents the energy of the Ising model.

$$\begin{matrix}[ Formula 1 ] & \\ {E}_{Ising} = {\sum }_{i = 1}^{N} {h}_{i} {s}_{i} + \frac{1}{2} {\sum }_{i = 1}^{N} {\sum }_{j = 1}^{N} {J}_{i , j} {s}_{i} {s}_{j} & ( 1 )\end{matrix}$$

Here, sᵢ and sⱼ are spins, and the spins are binary variables each having a value of either +1 or −1. N is the number of spins. Further, hᵢ is a local magnetic field acting on each spin. J is a matrix of coupling coefficients between spins. The matrix J is a real symmetric matrix whose diagonal components are 0. Therefore, Jᵢⱼ indicates an element in row i and column j of the matrix J. Note that the Ising model of Formula (1) is a quadratic expression for the spin, an extended Ising model (Ising model having a many-body interaction) including a third-order or higher-order term of the spin may be used as will be described later.

When the Ising model of Formula (1) is used, energy E_{Ising} can be used as an objective function, and it is possible to calculate a solution that minimizes energy E_{Ising} as much as possible. The solution of the Ising model is expressed in a format of a spin vector (s₁, s₂, . . . , s_{N}). This vector is referred to as a solution vector. In particular, the vector (s₁, s₂, . . . , s_{N}) having the minimum value of the energy E_{Ising} is referred to as an optimal solution. However, the solution of the Ising model to be calculated is not necessarily a strictly optimal solution. Hereinafter, a problem of obtaining an approximate solution (that is, an approximate solution in which a value of the objective function is as close as possible to the optimal value) in which the energy E_{Ising} is minimized as much as possible using the Ising model is referred to as an Ising problem.

Since the spin sᵢ in Formula (1) is a binary variable, conversion with a discrete variable (bit) used in the combinatorial optimization problem can be easily performed using Formula (1+sᵢ)/2. Therefore, it is possible to obtain a solution of the combinatorial optimization problem by converting the combinatorial optimization problem into the Ising problem and causing the Ising machine to perform calculation. A problem of obtaining a solution that minimizes a quadratic objective function having a discrete variable (bit), which takes a value of either 0 or 1, as a variable is referred to as a quadratic unconstrained binary optimization (QUBO) problem. It can be said that the Ising problem represented by Formula (1) is equivalent to the QUBO problem.

For example, a quantum annealer, a coherent Ising machine, a quantum bifurcation machine have been proposed as hardware implementations of the Ising Machine. The quantum annealer implements quantum annealing using a superconducting circuit. The coherent Ising machine uses an oscillation phenomenon of a network formed by an optical parametric oscillator. The quantum bifurcation machine uses a quantum mechanical bifurcation phenomenon in a network of a parametric oscillator with the Kerr effect. These hardware implementations have the possibility of significantly reducing a calculation time, but also have a problem that it is difficult to achieve scale-out and a stable operation.

Therefore, it is also possible to solve the Ising problem using a widely-spread digital computer. As compared with the hardware implementations using the above-described physical phenomenon, the digital computer facilitates the scale-out and the stable operation. An example of an algorithm for solving the Ising problem in the digital computer is simulated annealing (SA). A technique for performing simulated annealing at a higher speed has been developed. However, general simulated annealing is a sequential updating algorithm where each of variables is updated sequentially, and thus, it is difficult to speed up calculation processes by parallelization.

Taking the above-described problem into consideration, a simulated bifurcation algorithm, capable of solving a large-scale combinatorial optimization problem at a high speed by parallel calculation in the digital computer, has been proposed. Hereinafter, a description will be given regarding an information processing device, an information processing system, an information processing method, a storage medium, and a program for solving a combinatorial optimization problem using the simulated bifurcation algorithm.

First, an overview of the simulated bifurcation algorithm will be described.

In the simulated bifurcation algorithm, a simultaneous ordinary differential equation in (2) below is numerically solved for each of two variables xᵢ and yᵢ (i=1, 2, . . . , N), the number of each of the variables being N. Each of the N variables xᵢ corresponds to the spin sᵢ of the Ising model. On the other hand, each of the N variables yᵢ corresponds to the momentum. It is assumed that both the variables xᵢ and yᵢ are continuous variables. Hereinafter, a vector having the variable xᵢ (i=1, 2, . . . , N) as an element is referred to as a first vector, and a vector having the variable yᵢ (i=1, 2, . . . , N) as an element is referred to as a second vector.

$$\begin{matrix} [ Formula 2 ] & \\ \frac{{dx}_{i}}{dt} = \frac{\partial H}{\partial {y}_{i}} = {Dy}_{i} \\ \frac{{dy}_{i}}{dt} = - \frac{\partial H}{\partial {x}_{i}} = \{ - D + p ( t ) - {Kx}_{i}^{2} ) \} {x}_{i} - {ch}_{i} a ( t ) - c {\sum }_{j = 1}^{N} {J}_{ij} {x}_{j} & ( 2 )\end{matrix}$$

Here, H is a Hamiltonian of the following Formula (3).

$$\begin{matrix} [ Formula 3 ] & \\ H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + {ch}_{i} {x}_{i} a ( t ) + \frac{c}{2} {\sum }_{j = 1}^{N} {J}_{ij} {x}_{i} {x}_{j} ] & ( 3 )\end{matrix}$$

Note that, in (2), a Hamiltonian H′ including a term G (x₁, x₂, . . . , x_{N}) expressed in the following Formula (4) may be used instead of the Hamiltonian H of Formula (3). A function including not only the Hamiltonian H but also the term G (x₁, x₂, . . . , x_{N}) is referred to as an extended Hamiltonian to be distinguished from the original Hamiltonian H.

$$\begin{matrix} [ Formula 4 ] & \\ {H}^{′} = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + {ch}_{i} {x}_{i} a ( t ) + \frac{c}{2} {\sum }_{j = 1}^{N} {J}_{ij} {x}_{i} {x}_{j} ] + G ( {x}_{1} , {x}_{2} , … , {x}_{N} ) & ( 4 )\end{matrix}$$

Hereinafter, processing will be described by taking a case where the term G (x₁, x₂, . . . , x_{N}) is a correction term as an example. However, the term G (x₁, x₂, . . . , x_{N}) may be derived from a constraint condition of a combinatorial optimization problem. However, a deriving method and a type of the term G (x₁, x₂, . . . , x_{N}) are not limited. In addition, the term G (x₁, x₂, . . . , x_{N}) is added to the original Hamiltonian H in Formula (4). However, the term G (x₁, x₂, . . . , x_{N}) may be incorporated into the extended Hamiltonian using a different method.

Referring to the Hamiltonian of Formula (3) and the extended Hamiltonian of Formula (4), each term is either the element xᵢ of the first vector or the element yᵢ of the second vector. As expressed in the following Formula (5), an extended Hamiltonian that can be divided into a term U of the element xᵢ of the first vector and a term V of the element yᵢ of the second vector may be used.

[Formula 5]

H′=U(x₁, . . . ,x_{N})+V(y₁, . . . ,y_{N}) (5)

In calculation of time evolution of the simulated bifurcation algorithm, values of the variables xᵢ and yᵢ (i=1, 2, . . . , N) are repeatedly updated. Then, the spin sᵢ (i=1, 2, . . . , N) of the Ising model can be obtained by converting the variable xᵢ when a predetermined condition is satisfied. Hereinafter, processing will be described assuming a case where the time evolution is calculated. However, the simulated bifurcation algorithm may be calculated using a scheme other than the time evolution.

In (2) and (3), a coefficient D corresponds to detuning. A coefficient p(t) corresponds to the above-described first coefficient and is also referred to as a pumping amplitude. In the calculation of the time evolution, a value of the coefficient p(t) can be monotonically increased depending on the number of updates. An initial value of the coefficient p(t) may be set to 0.

Note that a case where the first coefficient p(t) is a positive value and a value of the first coefficient p(t) increases depending on the number of updates will be described as an example hereinafter. However, the sign of the algorithm to be presented below may be inverted, and the first coefficient p(t) as a negative value may be used. In this case, the value of the first coefficient p(t) monotonically decreases depending on the number of updates. In either case, however, the absolute value of the first coefficient p(t) monotonically increases depending on the number of updates.

A coefficient K corresponds to a positive Kerr coefficient. As a coefficient c, a constant coefficient can be used. For example, a value of the coefficient c may be determined before execution of calculation according to the simulated bifurcation algorithm. For example, the coefficient c can be set to a value close to an inverse number of the maximum eigenvalue of the J⁽²⁾ matrix. For example, a value of c=0.5D√(N/2n) can be used. Here, n is the number of edges of a graph related to the combinatorial optimization problem. In addition, a(t) is a coefficient that increases with p(t) at the time of calculating the time evolution. For example, √(p(t)/K) can be used as a(t). Note that the vector hᵢ of the local magnetic field in (3) and (4) can be omitted.

For example, when the value of the coefficient p(t) exceeds a predetermined value, a solution vector having the spin sᵢ as an element can be obtained by converting a variable xᵢ, which is a positive value, into +1 and a variable xᵢ, which is a negative value, into −1 in the first vector. This solution vector corresponds to the solution of the Ising problem. Note that the information processing device may execute the above-described conversion processing based on the number of updates of the first vector and the second vector, and determine whether to obtain the solution vector.

In the case of performing the calculation of the simulated bifurcation algorithm, the solution can be performed by converting the above-described (2) into a discrete recurrence formula using the Symplectic Euler method. The following (6) represents an example of the simulated bifurcation algorithm after being converted into the recurrence formula.

$$\begin{matrix} [ Formula 6 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + \{ \{ - D + p ( t + Δ t ) - {Kx}_{i}^{2} ( t + Δ t ) \} {x}_{i} ( t + Δ t ) - {ch}_{i} a ( t + Δ t ) ] Δ t - c Δ t {\sum }_{j = 1}^{N} {J}_{i . j} {x}_{j} ( t + Δ t ) & ( 6 )\end{matrix}$$

Here, t is time, and Δt is a time step (time increment). Note that the time t and the time step Δt are used to indicate the correspondence relationship with the differential equation in (6). However, the time t and the time step Δt are not necessarily included as explicit parameters when actually implementing the algorithm in software or hardware. For example, if the time step Δt is 1, the time step Δt can be removed from the algorithm at the time of implementation. In a case where the time t is not included as the explicit parameter when the algorithm is implemented, xᵢ(t+Δt) may be interpreted as an updated value of xᵢ(t) in (4). That is, “t” in the above-described (4) indicates a value of the variable before update, and “t+Δt” indicates a value of the variable after update.

In the case of calculating the time evolution of the simulated bifurcation algorithm, the value of the spin sᵢ can be obtained based on the sign of the variable xᵢ after increasing the value of p(t) from the initial value (for example, 0) to a predetermined value. For example, if a signum function of sgn(xᵢ)=+1 when xᵢ>0 and sgn(xᵢ)=−1 when xᵢ<0 is used, the value of the spin sᵢ can be obtained by converting the variable xᵢ with the signum function when the value of p(t) increases to the predetermined value. As the signum function, for example, it is possible to use a function that enables sgn(xᵢ)=xᵢ/|xᵢ| when xᵢ≠0 and sgn(xᵢ)=+1 or −1 when xᵢ=0. A timing of obtaining the solution (for example, the spin sᵢ of the Ising model) of the combinatorial optimization problem is not particularly limited. For example, the solution (solution vector) of the combinatorial optimization problem may be obtained when the number of updates of the first vector and the second vector, the value of the first coefficient p, or the value of the objective function becomes larger than a threshold.

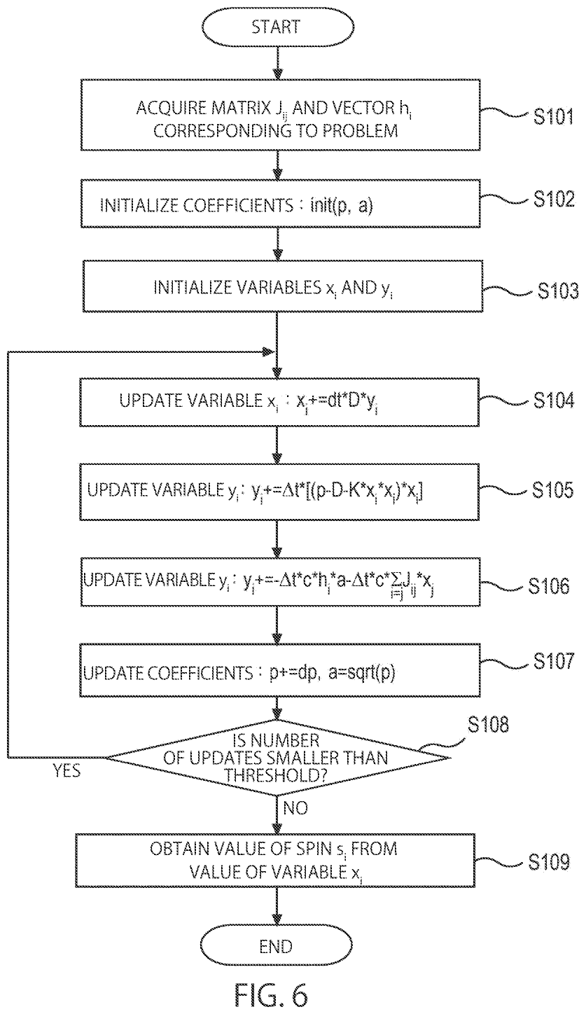

The flowchart of FIG. 6 illustrates an example of processing in the case where the solution of the simulated bifurcation algorithm is calculated by the time evolution. Hereinafter, the processing will be described with reference to FIG. 6.

First, the calculation server acquires the matrix Jᵢⱼ and the vector hᵢ corresponding to a problem from the management server 1 (step S101). Then, the calculation server initializes the coefficients p(t) and a(t) (step S102). For example, values of the coefficients p and a can be set to 0 in step S102, but the initial values of the coefficients p and a are not limited. Next, the calculation server initializes the first variable xᵢ and the second variable yᵢ (step S103). Here, the first variable xᵢ is an element of the first vector. In addition, the second variable yᵢ is an element of the second vector. In step S103, the calculation server may initialize xᵢ and yᵢ using pseudorandom numbers, for example. However, a method for initializing xᵢ and yᵢ is not limited. In addition, the variables may be initialized at different timings, or at least one of the variables may be initialized a plurality of times.

Next, the calculation server updates the first vector by performing weighted addition on the element yᵢ of the second vector corresponding to the element xᵢ of the first vector (step S104). For example, Δt×D×yᵢ can be added to the variable xᵢ in step S104. Then, the calculation server updates the element yᵢ of the second vector (steps S105 and S106). For example, Δt×[(p−D−K×xᵢ×xᵢ)×xᵢ] can be added to the variable yᵢ in step S105. In step S106, −Δt×c×hᵢ×a−Δt×c×ΣJᵢⱼ×xⱼ can be further added to the variable yᵢ.

Next, the calculation server updates the values of the coefficients p and a (step S107). For example, a constant value (Δp) may be added to the coefficient p, and the coefficient a may be set to a positive square root of the updated coefficient p. However, this is merely an example of a method for updating the values of the coefficients p and a as will be described later. Then, the calculation server determines whether the number of updates of the first vector and the second vector is smaller than the threshold (step S108). When the number of updates is smaller than the threshold (YES in step S108), the calculation server executes the processes of steps S104 to S107 again. When the number of updates is equal to or larger than the threshold (NO in step S108), the spin sᵢ, which is the element of the solution vector, is obtained based on the element xᵢ of the first vector (step S109). In step S109, the solution vector can be obtained, for example, in the first vector by converting the variable xᵢ which is the positive value into +1 and the variable xᵢ which is the negative value into −1.

Note that when the number of updates is smaller than the threshold in the determination in step S108 (YES in step S108), a value of the Hamiltonian may be calculated based on the first vector, and the first vector and the value of the Hamiltonian may be stored. As a result, a user can select an approximate solution closest to the optimal solution from the plurality of first vectors.

Note that at least one of the processes illustrated in the flowchart of FIG. 6 may be executed in parallel. For example, the processes of steps S104 to S106 may be executed in parallel such that at least some of the N elements included in each of the first vector and the second vector are updated in parallel. For example, the processes may be performed in parallel using a plurality of calculation servers. The processes may be performed in parallel by a plurality of processors. However, an implementation for realizing parallelization of the processes and a mode of the parallelization of the processes are not limited.

The execution order of processes of updating the variables xᵢ and yᵢ illustrated in steps S105 to S106 described above is merely an example. Therefore, the processes of updating the variables xᵢ and yᵢ may be executed in a different order. For example, the order in which the process of updating the variable xᵢ and the process of updating the variable yᵢ are executed may be interchanged. In addition, the order of sub-processing included in the process of updating each variable is not limited. For example, the execution order of the addition process included in the process of updating the variable yᵢ may be different from the example of FIG. 6. The execution order and timing of processing as a precondition for executing the process of updating each variable are also not particularly limited. For example, the calculation process of the problem term may be executed in parallel with other processes including the process of updating the variable xᵢ. The same applies to the processing in each flowchart to be described hereinafter, in that the execution order and timings of the processes of updating the variables xᵢ and yᵢ, the sub-processing included in the process of updating each variable, and the calculation process of the problem term are not limited.

### [Efficient Solution Search]

In calculation of an optimization problem including a simulated bifurcation algorithm, it is desirable to obtain an optimal solution or an approximate solution (referred to as a practical solution) close thereto. However, the practical solution is not necessarily obtained in each trial of the calculation process (for example, the processing of FIG. 6). For example, there is also a possibility that the solution obtained after the trial of the calculation process is not the practical solution but a local solution. In addition, there is also a possibility that a plurality of local solutions exist for a problem. In order to increase the probability of finding the practical solution, it is conceivable to cause each of a plurality of calculation nodes to execute the calculation process. In addition, it is also possible for a calculation node to execute iterative calculation processes and search for a solution a plurality of times. Further, the former method and the latter method may be combined.

Here, the calculation node is, for example, a calculation server (information processing device), a processor (CPU), a GPU, a semiconductor circuit, a virtual machine (VM), a virtual processor, a CPU thread, or a process. The calculation node may be any calculation resource that can be a subject that executes the calculation process, and does not limit the granularity and distinction between hardware and software.

However, when each of the calculation nodes independently executes the calculation process, there is a possibility that the plurality of calculation nodes search an overlapping region of a solution space. In addition, in the case where the calculation process is repeated, the calculation node is also likely to search the same region of the solution space in a plurality of trials. Therefore, the same local solution is calculated by a plurality of calculation nodes, or the same local solution is repeatedly calculated. It is ideal to find the optimal solution by searching for all local solutions of the solution space in the calculation process and evaluating each of the local solutions. However, considering that a large number of local solutions are likely to exist in the solution space, it is desirable that the information processing device or information processing system execute a process of efficiently obtaining a solution and obtains a practical solution within ranges of a pragmatic calculation time and a calculation amount.

For example, the calculation node can store a calculated first vector in a storage unit in the middle of a calculation process. In subsequent calculation processes, the calculation node reads the previously calculated first vector x^{(m)} from the storage unit. Here, m is a number indicating a timing at which an element of the first vector is obtained. For example, m=1 in the first vector obtained for the first time, and m=2 in the first vector obtained for the second time. Then, the calculation node executes a correction process based on the previously calculated first vector x^{(m)}. As a result, it is possible to avoid the search of the overlapping region in the solution space, and it is possible to search a wider region of the solution space with the same calculation time and calculation amount. Hereinafter, the previously calculated first vector is referred to as a searched vector to be distinguished from the first vector to be updated.

Hereinafter, details of processing for searching for an efficient solution will be described.

For example, the correction process can be performed using the above-described correction term G (x₁, x₂, . . . , x_{N}). The following Formula (7) is an example of a distance between the first vector and the searched vector.

$$\begin{matrix}[ Formula 7 ] & \\ ‖ x - {x}^{( m )} ‖ = {\{ {\sum }_{i = 1}^{N} {\vert {x}_{i} - {x}_{i}^{( m )} \vert}^{Q} \}}^{1 / Q} & ( 7 )\end{matrix}$$

Formula (7) is referred to as a Q-th power norm. In Formula (7), Q can take any positive value.

The following Formula (8) is obtained by making Q of Formula (7) infinite, and is called an infinite power norm.

[Formula 8]

∥x−x^{(m)}∥=max{|x₁|, . . . ,|x_{N}|} (8)

Hereinafter, a case where a square norm is used as the distance will be described as an example. However, a type of distance used in the calculation is not limited.

For example, as expressed in the following Formula (9), the correction term G (x₁, x₂, . . . , x_{N}) may include an inverse number of the distance between the first vector and the searched vector.

$$\begin{matrix}[ Formula 9 ] & \\ {c}_{A} \frac{1}{{‖ x - {x}^{( m )} ‖}^{{k}_{A}}} & ( 9 )\end{matrix}$$

In this case, when the first vector in the middle of calculation approaches the searched vector, a value of the correction term G (x₁, x₂, . . . , x_{N}) increases. As a result, it is possible to execute the process of updating the first vector so as to avoid a region near the searched vector. (9) is only one example of the correction term that can be used for the calculation. Therefore, a correction term in a format different from that of (9) may be used in the calculation.

The following Formula (10) is an example of the extended Hamiltonian H′ including the correction term.

$$\begin{matrix} [ Formula 10 ] & \\ {H}^{′} = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} - c {h}_{i} {x}_{i} a ( t ) - \frac{c}{2} {\sum }_{j = 1}^{N} {J}_{ij} {x}_{i} {x}_{j} ] + {c}_{A} {\sum }_{m = 1}^{M} \frac{1}{{‖ x - {x}^{( m )} ‖}^{{k}_{A}}} & ( 10 )\end{matrix}$$

For example, any positive value can be used as a coefficient c_{A} of Formula (10). In addition, any positive value can be used as k_{A}. The correction term of (10) includes the sum of inverse numbers of distances calculated using the respective searched vectors obtained so far. That is, the processing circuit of the information processing device may be configured to calculate inverse numbers of distances respectively using the plurality of searched vectors and calculate the correction term by adding the plurality of inverse numbers. As a result, the process of updating the first vector can be executed so as to avoid regions near the plurality of searched vectors obtained so far.

In a case where the extended Hamiltonian of Formula (10) is used, it is possible to execute a process of numerically solving a simultaneous ordinary differential equation expressed in (11) below for each of the two variables xᵢ and yᵢ (i=1, 2, . . . , N), the number of each of the variables being N.

$$\begin{matrix} [ Formula 11 ] & \\ \frac{\partial {x}_{i}}{\partial t} = \frac{\partial {H}^{′}}{\partial {y}_{i}} = D {y}_{i} \\ \frac{\partial {y}_{i}}{\partial t} = - \frac{\partial {H}^{′}}{\partial {x}_{i}} = - [ ( D - p ( t ) + {Kx}_{i}^{2} ) {x}_{i} + c {h}_{i} a ( t ) + c {\sum }_{j = 1}^{N} {J}_{i j} {x}_{j} ] + {k}_{A} {c}_{A} {\sum }_{m = 1}^{M} \frac{x - {x}^{( m )}}{{‖ x - {x}^{( m )} ‖}^{{k}_{A} + 2}} & ( 11 )\end{matrix}$$

The following (12) is obtained by partially differentiating (10) with respect to xᵢ.

$$\begin{matrix}[ Formula 12 ] & \\ {k}_{A} {c}_{A} {\sum }_{m = 1}^{M} \frac{x - {x}^{( m )}}{{‖ x - {x}^{( m )} ‖}^{{k}_{A} + 2}} & ( 12 )\end{matrix}$$

In a case where a denominator of the correction term of (10) is a square norm, calculation of a square root is unnecessary in calculation of a denominator of (12), and thus, the calculation amount can be suppressed. For example, when the number of elements of the first vectors is N and the number of searched vectors held in the storage unit is M, the correction term can be obtained with a calculation amount that is a constant multiple of N×M.

The above-described (11) can be converted into a discrete recurrence formula using the simple Euler method to perform calculation of the simulated bifurcation algorithm. The following (13) represents an example of the simulated bifurcation algorithm after conversion into the recurrence formula.

$$\begin{matrix} [ Formula 13 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + p ( t + Δ t ) - {Kx}_{i}^{2} \} {x}_{i} ( t + Δ t ) ] Δ t - {ch}_{i} a ( t + Δ t ) Δ t - c Δ t {\sum }_{j = 1}^{N} {J}_{i , j} {x}_{j} ( t + Δ t ) + {k}_{A} {c}_{A} {\sum }_{m = 1}^{M} \frac{x ( t + Δ t ) - {x}^{( m )}}{{‖ x ( t + Δ t ) - {x}^{( m )} ‖}^{{k}_{A} + 2}} & ( 13 )\end{matrix}$$

When the algorithm of (13) is used, it is possible to adaptively update the first vector depending on the searched vector.

In (13), a term of the following (14) is derived from the Ising energy. Since a format of this term is determined depending on a problem to be solved, the term is referred to as a problem term.

$$\begin{matrix}[ Formula 14 ] & \\ - {ch}_{i} a ( t + Δ t ) Δ t - c Δ t {\sum }_{j = 1}^{N} {J}_{i , j} {x}_{j} ( t + Δ t ) & ( 14 )\end{matrix}$$

The problem term may be different from (14) as will be described later.

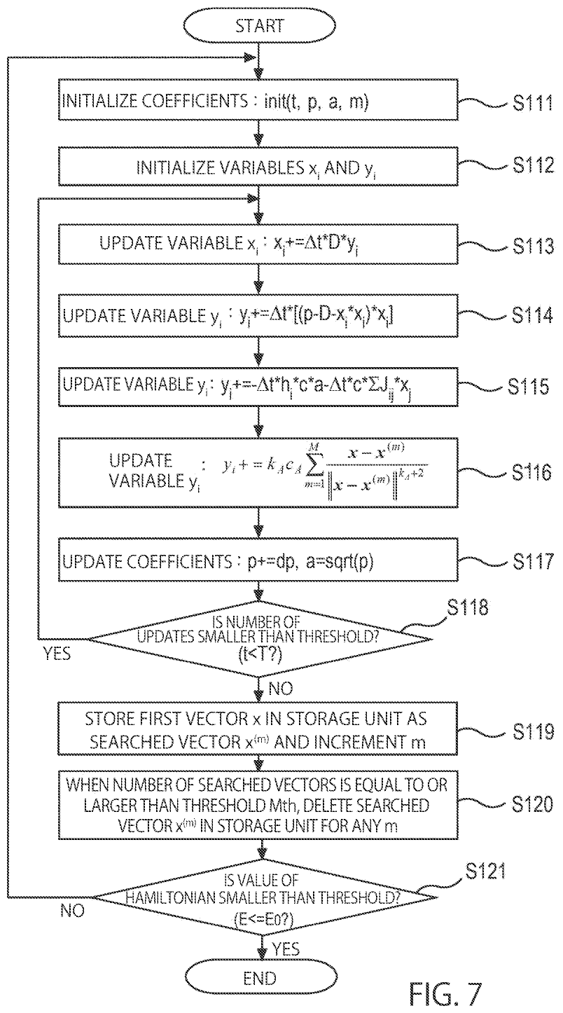

A flowchart of FIG. 7 illustrates an example of processing in a case where a solution is obtained using an algorithm including a correction term. Hereinafter, the processing will be described with reference to FIG. 7.

First, the calculation server initializes the coefficients p(t) and a(t) and the variable m (step S111). For example, values of the coefficients p and a can be set to 0 in step S111, but the initial values of the coefficients p and a are not limited. For example, the variable m can be set to 1 in step S111. Note that it is assumed that the calculation server acquires the matrix Jᵢⱼ and the vector hᵢ corresponding to a problem from the management server 1 before the processing of the flowchart of FIG. 7 is started although not illustrated. Next, the calculation server initializes the first variable xᵢ and the second variable yᵢ (step S112). Here, the first variable xᵢ is an element of the first vector. In addition, the second variable yᵢ is an element of the second vector. In step S112, the calculation server may initialize xᵢ and yᵢ using pseudorandom numbers, for example. However, a method for initializing xᵢ and yᵢ is not limited.

Then, the calculation server updates the first vector by performing weighted addition on the second variable yᵢ corresponding to the first variable xᵢ (step S113). For example, Δt×D×yᵢ can be added to the variable xᵢ in step S113. Next, the calculation server updates the second variable yᵢ (steps S114 to S116). For example, Δt×[(p−D−K×xᵢ×xᵢ)×xᵢ] can be added to yᵢ in step S114. In step S115, −Δt×c×hᵢ×a−Δt×c×ΣJᵢⱼ×xⱼ can be further added to yᵢ. Step S115 corresponds to a process of adding the problem term to the second variable yᵢ. In step S116, a correction term of (12) can be added to yᵢ. The correction term can be calculated, for example, based on the searched vector and the first vector stored in the storage unit.

Next, the calculation server updates values of the coefficients p (first coefficients) and a (step S117). For example, a constant value (Δp) may be added to the coefficient p, and the coefficient a may be set to a positive square root of the updated coefficient p. However, this is merely an example of the method for updating the values of the coefficients p and a as will be described later. In addition, in a case where the variable t is used to determine whether to continue a loop, Δt may be added to the variable t. Then, the calculation server determines whether the number of updates of the first vector and the second vector is smaller than a threshold (step S118). For example, the determination of step S118 can be performed by comparing the value of the variable t with T. However, the determination may be performed by other methods.

When the number of updates is smaller than the threshold (YES in step S118), the calculation server executes the processes of steps S113 to S117 again. When the number of updates is equal to or larger than the threshold (NO in step S118), the first vector is stored in the storage unit as a searched vector, and m is incremented (step S119). Then, when the number of searched vectors stored in the storage unit is equal to or larger than a threshold Mth, the searched vector in the storage unit is deleted for any m (step S120). Note that the process of storing the first vector in the storage unit as the searched vector may be executed at any timing between the execution of step S113 and step S117.

Next, the calculation server substitutes the first vector and the second vector for the Hamiltonian of Formula (6) described above, thereby calculating a value E of the Hamiltonian. Then, the calculation server determines whether the value E of the Hamiltonian is smaller than a threshold E₀ (step S121). When the value E of the Hamiltonian is smaller than the threshold E₀ (YES in step S121), the calculation server can obtain the spin sᵢ, which is the element of the solution vector, based on the first variable xᵢ (not illustrated). The solution vector can be obtained, for example, in the first vector by converting the first variable xᵢ which is the positive value into +1 and the first variable xᵢ which is the negative value into −1.

In the determination in step S121, when the value E of the Hamiltonian is not smaller than the threshold E₀ (NO in step S121), the calculation server executes the processes of step S111 and the subsequent steps again. In this manner, it is confirmed whether an optimal solution or an approximate solution close thereto has been obtained in the determination in step S121. In this manner, the processing circuit of the information processing device may be configured to determine whether to stop updating the first vector and the second vector based on the value of the Hamiltonian (objective function).

The user can determine the value of the threshold E₀ depending on the sign used in the formulation of the problem and the accuracy sought in obtaining the solution. If there is a case where a first vector in which the value of the Hamiltonian takes a local minimum value is the optimal solution depending on the sign used in the formulation, there may also be a case where a first vector in which the value of the Hamiltonian takes a local maximum value is the optimal solution. For example, in the extended Hamiltonian in (10) described above, a first vector having a local minimum value is the optimal solution.

Note that the calculation server may calculate the value of the Hamiltonian at any timing. The calculation server can store the value of the Hamiltonian and the first vector and the second vector used for the calculation in the storage unit. The processing circuit of the information processing device may be configured to store the updated second vector as a third vector in the storage unit. In addition, the processing circuit may be configured to read the third vector updated to the same iteration as the searched vector from the storage unit, and calculate the value of the Hamiltonian (objective function) based on the searched vector and the third vector.

The user can determine the frequency of calculating the value of the Hamiltonian depending on an available storage area and the amount of calculation resources. In addition, whether to continue the loop processing may be determined based on whether the number of combinations of the values of the first vector, the second vector, and the Hamiltonian stored in the storage unit exceeds a threshold at the timing of step S118. In this manner, the user can select the searched vector closest to the optimal solution from the plurality of searched vectors stored in the storage unit and calculate the solution vector.

The processing circuit of the information processing device may be configured to select any searched vector from the plurality of searched vectors stored in the storage unit based on the value of the Hamiltonian (objective function), and calculate the solution vector by converting a first variable, which is a positive value of the selected searched vector, into a first value and converting a first variable, which is a negative value, into a second value smaller than the first value. Here, the first value is, for example, +1. The second value is, for example, −1. However, the first value and the second value may be other values.

Note that at least one of the processes illustrated in the flowchart of FIG. 7 may be executed in parallel. For example, the processes of steps S113 to S116 may be executed in parallel such that at least some of the N elements included in each of the first vector and the second vector are updated in parallel. For example, the processes may be performed in parallel using a plurality of calculation servers. The processes may be performed in parallel by a plurality of processors. However, an implementation for realizing parallelization of the processes and a mode of the parallelization of the processes are not limited.

In step S120 of FIG. 7, the process of deleting one of the searched vectors stored in the storage unit is executed. In step S120, the searched vector to be deleted can be randomly selected. For example, in a case where there is a limit on the available storage area, the above-described threshold Mth can be determined based on the limit. In addition, the calculation amount in step S116 (calculation of the correction term) can be suppressed by setting an upper limit to the number of searched vectors held in the storage unit regardless of the limit on the available storage area. Specifically, the process of calculating the correction term can be executed with a calculation amount equal to or less than a constant multiple of N× Mth.

However, the calculation server may always skip the process of step S120 or may execute the other process at the timing of step S120. For example, the searched vector may be migrated to another storage. In addition, when there are sufficient calculation resources, it is unnecessary to perform the process of deleting the searched vector.

Here, examples of the information processing method, the storage medium, and the program will be described.

In a first example of the information processing method, a storage unit and a plurality of processing circuits are used to repeatedly update a first vector which has a first variable as an element and a second vector which has a second variable corresponding to the first variable as an element. In this case, the information processing method may include: a step of updating the first vector by performing weighted addition of the corresponding second variable to the first variable by the plurality of processing circuits; a step of storing the first vector updated by the plurality of processing circuits in the storage unit as a searched vector; a step of performing weighting of the first variable with a first coefficient that monotonically increases or monotonically decreases depending on the number of updates and adding the weighted first variable to the corresponding second variable by the plurality of processing circuits; a step of calculating a problem term using the plurality of first variables and adding the problem term to the second variable by the plurality of processing circuits; a step of reading the searched vector from the storage unit by the plurality of processing circuits; a step of calculating a correction term including an inverse number of a distance between the first vector to be updated and the searched vector by the plurality of processing circuits; and a step of adding the correction term to the second variable by the plurality of processing circuits.

In a second example of the information processing method, a storage device and a plurality of information processing devices are used to repeatedly update a first vector which has a first variable as an element and a second vector which has a second variable corresponding to the first variable as an element. In this case, the information processing method may include: a step of updating the first vector by performing weighted addition of the corresponding second variable to the first variable by the plurality of information processing devices; a step of storing the first vector updated by the plurality of information processing devices in the storage device as a searched vector; a step of performing weighting of the first variable with a first coefficient that monotonically increases or monotonically decreases depending on the number of updates and adding the weighted first variable to the corresponding second variable by the plurality of information processing devices; a step of calculating a problem term using the plurality of first variables and adding the problem term to the second variable by the plurality of information processing devices; a step of reading the searched vector from the storage device by the plurality of information processing devices; a step of calculating a correction term including an inverse number of a distance between the first vector to be updated and the searched vector by the plurality of information processing devices; and a step of adding the correction term to the second variable by the plurality of information processing devices.

For example, the program repeatedly updates a first vector which has a first variable as an element and a second vector which has a second variable corresponding to the first variable as an element. In this case, the program may cause a computer to execute: a step of updating the first vector by performing weighted addition of the corresponding second variable to the first variable; a step of storing the updated first vector in the storage unit as a searched vector; a step of performing weighting of the first variable with a first coefficient that monotonically increases or monotonically decreases depending on the number of updates and adding the weighted first variable to the corresponding second variable; a step of calculating a problem term using the plurality of first variables and adding the problem term to the second variable; a step of reading the searched vector from the storage unit; a step of calculating a correction term including an inverse number of a distance between the first vector to be updated and the searched vector; and a step of adding the correction term to the second variable. In addition, the storage medium may be a non-transitory computer-readable storage medium storing the above-described program.

### [Efficient Solution Search in Parallel System]

The above-described adaptive search can be applied even in a case where a plurality of calculation nodes execute the simulated bifurcation algorithm in parallel. Here, it is sufficient that the calculation node is any calculation resource that can be an execution subject of the calculation process, and the granularity and the distinction between hardware and software are not limited, which is similar to the above description. The plurality of calculation nodes may share and execute processes of update of the same pair of the first vector and the second vector. In this case, it can be said that the plurality of calculation nodes form one group that calculates the same solution vector. In addition, the plurality of calculation nodes may be divided into groups that execute processes of updating different pairs of the first vector and the second vector. In this case, it can be said that the plurality of calculation nodes are divided into a plurality of groups that calculate mutually different solution vectors.

The information processing device may include a plurality of processing circuits. In this case, each of the processing circuits may be divided into a plurality of groups that execute processes of updating different pairs of the first vector and the second vector. Each of the processing circuits may be configured to read the searched vector stored in the storage unit by the other processing circuit.

In addition, an information processing system including the storage device 7 and a plurality of information processing devices may repeatedly update a first vector which has a first variable as an element and a second vector which has a second variable corresponding to the first variable as an element. In this case, each of the information processing devices may be configured to update the first vector by weighted addition of the corresponding second variable to the first variable; store the updated first vector in the storage device 7 as a searched vector; perform weighting of the first variable with a first coefficient that monotonically increases or monotonically decreases depending on the number of updates and add the weighted first variable to the corresponding second variable; calculate a problem term using the plurality of first variables; add the problem term to the second variable; read the searched vector from the storage device 7; calculate a correction term including an inverse number of a distance between the first vector to be updated and the searched vector; and add the correction term to the second variable to update the second vector.

In the case where the information processing system includes the plurality of information processing devices, each of the information processing devices may be divided into a plurality of groups that execute processes of updating different pairs of the first vector and the second vector. Each of the information processing devices may be configured to read the searched vector stored in the storage unit by the other information processing device.

Hereinafter, an example of processing that enables efficient solution search in a case where each of a plurality of calculation nodes executes the simulated bifurcation algorithm will be described.

The following Formula (15) is an example of a Hamiltonian not including a correction term.

$$\begin{matrix} [ Formula 15 ] & \\ {H}^{( {m}_{1} )} = {\sum }_{i = 1}^{N} [ \frac{D}{2} ( {x}_{i}^{{( m 1 )}^{2}} + {y}_{i}^{{( m 1 )}^{2}} ) - \frac{p ( t )}{2} {x}_{i}^{{( m 1 )}^{2}} + \frac{K}{4} {x}_{i}^{{( m 1 )}^{4}} - {ch}_{i} {x}_{i}^{( m 1 )} a ( t ) - \frac{c}{2} {\sum }_{j = 1}^{N} {J}_{ij} {x}_{i}^{{( m 1 )}^{2}} {x}_{j}^{{( m 1 )}^{2}} ] & ( 15 )\end{matrix}$$

For example, when each of the calculation nodes is caused to independently calculate a solution using the Hamiltonian of Formula (15) described above, there is a possibility that the plurality of calculation nodes search an overlapping region in a solution space or the plurality of calculation nodes obtain the same local solution.

Therefore, a correction term such as (16) below can be used in order to avoid the search of the overlapping region in the solution space by different calculation nodes.

$$\begin{matrix}[ Formula 16 ] & \\ {c}_{G} {\sum }_{{m 2 = 1}_{m 2 \neq m 1}}^{M} \frac{1}{{‖ {x}^{( m 1 )} - {x}^{( m 2 )} ‖}^{{k}_{G}}} & ( 16 )\end{matrix}$$

In (15) and (16), m1 indicates a variable or a value used in the calculation of each of the calculation nodes. On the other hand, m2 indicates a variable used in the calculation by the other calculation node viewed from each of the calculation nodes. For example, the vector x^{(m1)} of (16) is a first vector calculated by the own calculation node. On the other hand, the vector x^{(m2)} is a first vector calculated by the other calculation node. That is, when the correction term of (16) is used, the first vector calculated by the other calculation node is used as a searched vector. In addition, any positive value can be set to c_{G} and k_{G} in (16). The values of c_{G} and k_{G} may be different.

For example, when the correction term of (16) is added to Formula (15), an extended Hamiltonian of the following Formula (17) is obtained.

$$\begin{matrix} [ Formula 17 ] & \\ {H}^{′ ( m 1 )} = {\sum }_{i = 1}^{N} [ \frac{D}{2} ( {x}_{i}^{{( m 1 )}^{2}} + {y}_{i}^{{( m 1 )}^{2}} ) - \frac{p ( t )}{2} {x}_{i}^{{( m 1 )}^{2}} + \frac{K}{4} {x}_{i}^{{( m 1 )}^{4}} - {ch}_{i} {x}_{i}^{( m 1 )} a ( t ) - \frac{c}{2} {\sum }_{j = 1}^{N} {J}_{ij} {x}_{i}^{{( m 1 )}^{2}} {x}_{j}^{{( m 1 )}^{2}} ] + {c}_{g} {\sum }_{{m 2 = 1}_{m 2 \neq m 1}}^{M} \frac{1}{{‖ {x}^{( m 1 )} - {x}^{( m 2 )} ‖}^{{k}_{G}}} & ( 17 )\end{matrix}$$

When the vector x^{(m1)} approaches a vector x^{(m2)} in the solution space, a value of a denominator decreases in each of the correction terms expressed in (16) and (17). Therefore, the value of (16) increases, and a process of updating the first vector x^{(m1)} is executed so as to avoid a region near the vector x^{(m2)} in each of the calculation nodes.

In a case where the extended Hamiltonian of Formula (17) is used, it is possible to execute a process of numerically solving a simultaneous ordinary differential equation expressed in (18) below for each of the two variables xᵢ and yᵢ (i=1, 2, . . . , N), the number of each of the variables being N.

$$\begin{matrix} [ Formula 18 ] & \\ \frac{\partial {x}_{i}}{\partial t} = \frac{\partial {H}^{′}}{\partial {y}_{i}} = {Dy}_{i} \\ \frac{\partial {y}_{i}}{\partial t} = - \frac{\partial {H}^{′}}{\partial {x}_{i}} = - [ ( D - p ( t ) + {Kx}_{i}^{2} ) {x}_{i} + {ch}_{i} a ( t ) + c {\sum }_{j = 1}^{N} {J}_{ij} {x}_{j} ] + {k}_{G} {c}_{G} {\sum }_{{m 2 = 1}_{m 2 \neq m 1}}^{M} \frac{{x}^{( m 1 )} - {x}^{( m 2 )}}{{‖ {x}^{( m 1 )} - {x}^{( m 2 )} ‖}^{{k}_{G} + 2}} & ( 18 )\end{matrix}$$

The following (19) is obtained by partially differentiating the correction term of (17) with respect to xᵢ.

$$\begin{matrix}[ Formula 19 ] & \\ {k}_{G} {c}_{G} {\sum }_{{m 2 = 1}_{m 2 \neq m 1}}^{M} \frac{{x}^{( m 1 )} - {x}^{( m 2 )}}{{‖ {x}^{( m 1 )} - {x}^{( m 2 )} ‖}^{{k}_{G} + 2}} & ( 19 )\end{matrix}$$

In a case where a denominator of the correction term of (16) is a square norm, calculation of a square root is unnecessary in calculation of a denominator of (19), and thus, the calculation amount can be suppressed. When N is the number of elements of the first vectors and M is the number of searched vectors by the other calculation nodes, the correction term of (19) can be calculated with a calculation amount that is a constant multiple of N×M.

The above-described (18) can be converted into a discrete recurrence formula using the simple Euler method to perform calculation of the simulated bifurcation algorithm. The following (20) represents an example of the simulated bifurcation algorithm after conversion into the recurrence formula.

$$\begin{matrix} [ Formula 20 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + p ( t + Δ t ) - {Kx}_{i}^{2} \} {x}_{i} ( t + Δ t ) ] Δ t - {ch}_{i} a ( t + Δ t ) Δ t - c Δ t {\sum }_{j = 1}^{N} {J}_{i , j} {x}_{j} ( t + Δ t ) + {k}_{G} {c}_{G} {\sum }_{m = 1}^{M} \frac{{x}^{( m 1 )} ( t + Δ t ) - {x}^{( m 2 )}}{{‖ {x}^{( m 1 )} ( t + Δ t ) - {x}^{( m 2 )} ‖}^{{k}_{G} + 2}} & ( 20 )\end{matrix}$$

The algorithm of (20) also includes the problem term of (14) described above. The problem term in a different format from (20) may be used as will be discussed later.

For example, the information processing device may include the plurality of processing circuits. Each of the processing circuits may be configured to store the updated first vector in the storage unit. As a result, each of the processing circuits can calculate the correction term using the searched vector calculated by the other processing circuit. In addition, each of the processing circuits may be configured to transfer the updated first vector to the other processing circuit and calculate the correction term using the first vector received from the other processing circuit instead of the searched vector.

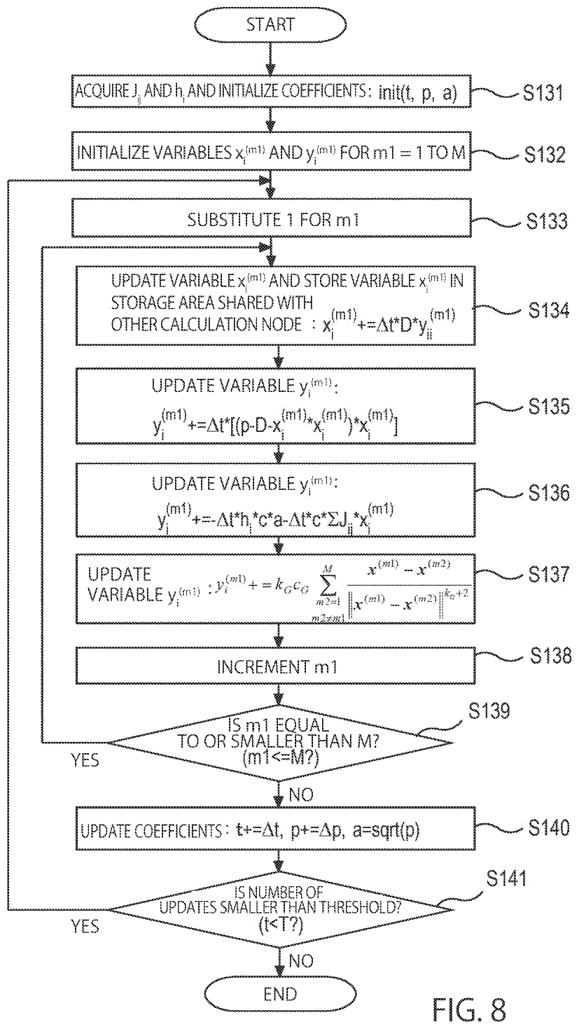

The flowchart of FIG. 8 illustrates an example of processing in a case where a solution is efficiently obtained using the first vector calculated by the other calculation node. Hereinafter, the processing will be described with reference to FIG. 8.

First, a calculation server acquires the matrix Jᵢⱼ and the vector hᵢ corresponding to a problem from the management server 1, and initializes the coefficients p(t) and a(t) and the variable t (step S131). For example, values of p, a, and t can be set to 0 in step S131. However, the initial values of p, a, and t are not limited. Next, the calculation server initializes a first variable xᵢ^{(m1)} and a second variable yᵢ^{(m1)} for m1=1 to M (step S132). Here, the first variable xᵢ^{(m1)} is an element of the first vector. The second variable yᵢ^{(m1)} is an element of the second vector. For example, xᵢ^{(m1)} and yᵢ^{(m1)} may be initialized using pseudo random numbers. However, a method for initializing xᵢ^{(m1)} and yᵢ^{(m1)} is not limited. Then, the calculation server substitutes 1 for a counter variable m1 (step S133). Here, the counter variable m1 is a variable that designates the calculation node. A calculation node #1 that performs a calculation process is specified by the process of step S133. Note that the processes in steps S131 to S133 may be executed by a computer other than the calculation server, such as the management server 1.

Next, the calculation node #(m1) updates the first vector by weighted addition of the second variable yᵢ^{(m1)} corresponding to the first variable xᵢ^{(m1)} and stores the updated first vector in a storage area shared with the other calculation node (step S134). For example, Δt×D×yᵢ^{(m1)} can be added to xᵢ^{(m1)} in step S134. For example, in a case where the other calculation node is the other processor or a thread on the other processor, the updated first vector can be stored in the shared memory 32 or the storage 34. In addition, in a case where the other calculation node is the calculation server, the first vector may be stored in a shared external storage. The other calculation node may utilize the first vector stored in the shared storage area as the searched vector. Note that the updated first vector may be transferred to the other calculation node in step S134.

Next, the calculation node #(m1) updates the second variable yᵢ^{(m1)} (steps S135 to S137). For example, Δt×[(p−D−K×xᵢ^{(m1)}×xᵢ^{(m1)})×xᵢ^{(m1)}] can be added to yᵢ^{(m1)} in step S135.

In step S136, −Δt×c×hᵢ×a−Δt×c×ΣJᵢⱼ×xⱼ^{(m1)} can be further added to yᵢ^{(m1)}. Step S136 corresponds to a process of adding the problem term to the second variable yᵢ. Then, the correction term of (19) can be added to the variable yᵢ in step S137. The correction term is calculated, for example, based on the first vector and the searched vector stored in the shared storage area. Then, the calculation server increments the counter variable m1 (step S138).

Next, the calculation server determines whether the counter variable 1 is equal to or smaller than M (step S139). When the counter variable m1 is equal to or smaller than M (YES in step S139), the processes in steps S134 to S138 are executed again. On the other hand, when the counter variable m1 is larger than M (NO in step S139), the calculation server updates the values of p, a, and t (step S140). For example, a constant value (Δp) can be added to p, a can be set to a positive square root of the updated coefficient p, and Δt can be added to t. However, this is merely an example of a method for updating the values of p, a, and t as will be described later. Then, the calculation server determines whether the number of updates of the first vector and the second vector is smaller than a threshold (step S141). For example, the determination of step S141 can be performed by comparing the value of the variable t with T. However, the determination may be performed by other methods.

When the number of updates is smaller than the threshold (YES in step S141), the calculation server executes the process in step S133, and the designated calculation node further executes the processes of step S134 and the subsequent steps. When the number of updates is equal to or larger than the threshold (NO in step S141), the calculation server or the management server 1 can obtain the spin sᵢ, which is an element of a solution vector, based on the first variable xᵢ (not illustrated). The solution vector can be obtained, for example, in the first vector by converting the first variable xᵢ which is the positive value into +1 and the first variable xᵢ which is the negative value into −1.

In the flowchart of FIG. 8, the calculation nodes #1 to #M sequentially execute processes of updating elements of the first vector and the second vector by a loop. However, the processes of steps S133, S138, and S139 in the flowchart of FIG. 8 may be skipped, and instead, the processes of steps S134 to S137 may be executed in parallel by a plurality of calculation nodes. In this case, a component (for example, the control unit 13 of the management server 1 or any calculation server) that manages the plurality of calculation nodes can execute the processes in steps S140 and S141. As a result, the overall calculation process can be speeded up.

The number M of the plurality of calculation nodes that execute the processes of steps S134 to S137 in parallel is not limited. For example, the number M of calculation nodes may be equal to the number N of elements (the number of variables) of each of the first vector and the second vector. In this case, one solution vector can be obtained by using the M calculation nodes.

In addition, the number M of calculation nodes may be different from the number N of elements of each of the first vector and the second vector. For example, the number M of calculation nodes may be a positive integral multiple of the number N of elements of each of the first vector and the second vector. In this case, M/N solution vectors can be obtained by using the plurality of calculation nodes. Then, the plurality of calculation nodes are grouped for each solution vector to be calculated. In this manner, the searched vector may be shared between the calculation nodes grouped so as to calculate mutually different solution vectors such that more efficient calculation process may be implemented. That is, the vector x^{(m2)} may be a first vector calculated by a calculation node belonging to the same group. In addition, the vector x^{(m2)} may be a first vector calculated by a calculation node belonging to a different group. Note that the processing is not necessarily synchronized between the calculation nodes belonging to different groups.

Note that the processes of steps S134 to S137 may be executed in parallel such that at least some of the N elements included in each of the first vector and the second vector are updated in parallel. Here, an implementation and an aspect of parallelization of processes are not limited.

Note that the calculation node may calculate a value of a Hamiltonian based on the first vector and the second vector at any timing. The Hamiltonian may be the Hamiltonian in (15) or the extended Hamiltonian including the correction term in (17). In addition, both the former and the latter may be calculated. The calculation node can store the values of the first vector, the second vector, and the Hamiltonian in the storage unit. These processes may be performed every time when the affirmative determination is made in step S141. In addition, the determination may be executed at some timings among timings at which the affirmative determination is made in step S141. Further, the above-described process may be executed at another timing. The user can determine the frequency of calculating the value of the Hamiltonian depending on an available storage area and the amount of calculation resources. Whether to continue the loop processing may be determined based on whether the number of combinations of the values of the first vector, the second vector, and the Hamiltonian stored in the storage unit exceeds a threshold at the timing of step S141. In this manner, a user can select the first vector closest to an optimal solution from the plurality of first vectors (local solutions) stored in the storage unit and calculate the solution vector.

### [Use of Snapshot]

Hereinafter, another example of processing applicable even to a case where a searched vector is shared across groups of calculation nodes that are calculating different pairs of a first vector and a second vector will be described. The calculation node may be any calculation resource that can be a subject of executing a calculation process. Therefore, the granularity of the calculation node and the distinction between hardware and software are not limited.

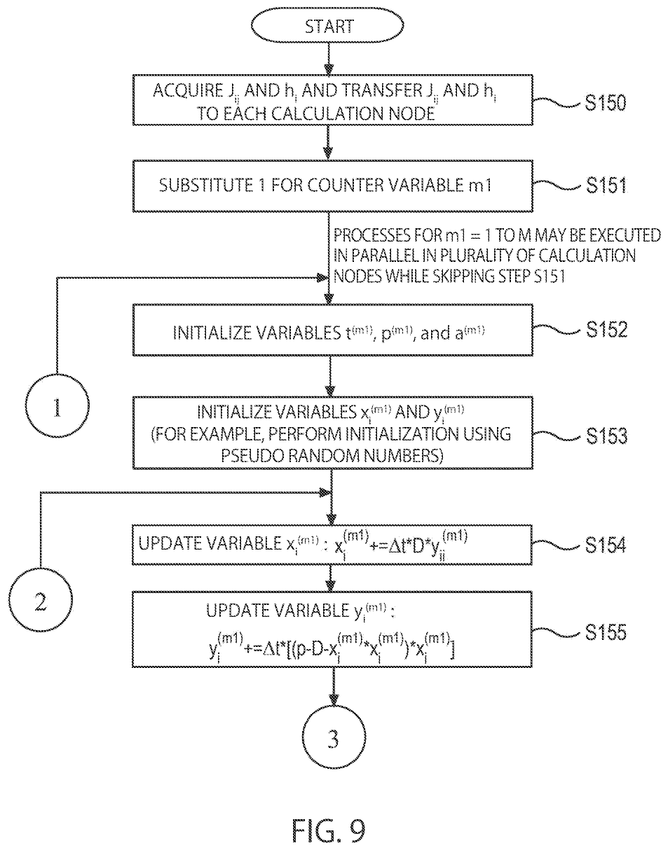

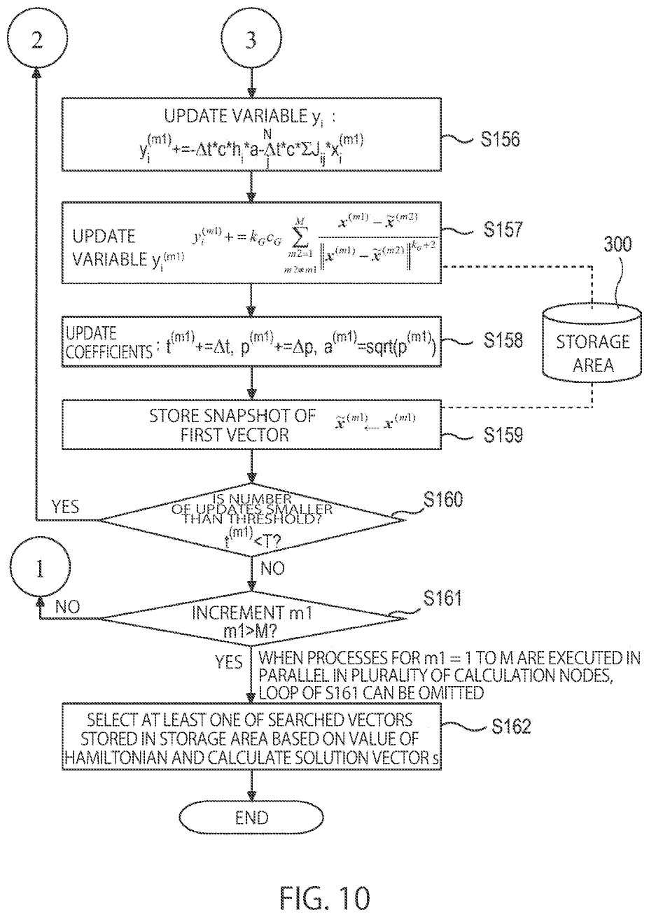

The flowcharts in FIGS. 9 and 10 illustrate an example of processing in a case where a solution is efficiently obtained by the simulated bifurcation algorithm in the plurality of calculation nodes. Hereinafter, the processing will be described with reference to FIGS. 9 and 10.

First, the calculation server acquires the matrix Jᵢⱼ and the vector hᵢ corresponding to a problem from the management server 1, and transfers these pieces of data to the respective calculation nodes (step S150). In step S150, the management server 1 may directly transfer the matrix Jᵢⱼ and the vector hᵢ corresponding to the problem to the respective calculation nodes. Next, the calculation server substitutes 1 for the counter variable m1 (step S151). Note that step S151 may be skipped. In this case, processes of steps S152 to S160 to be described later may be executed in parallel for m1=1 to M by the plurality of calculation nodes.

It is assumed that the variable m1 indicates a number of each of the calculation nodes in the information processing system regardless of the presence or absence of loop processing. In addition, m2 indicates a number of the other calculation node viewed from each of the calculation nodes. The number M of calculation nodes may be equal to the number N of elements of each of the first vector and the second vector. In addition, the number M of calculation nodes may be different from the number N of elements of each of the first vector and the second vector. Further, the number M of calculation nodes may be a positive integral multiple of the number N of elements of each of the first vector and the second vector.

Then, each of the calculation nodes initializes a variable t^{(m1)} and coefficients p^{(m1)} and a^{(m1)} (step S152). For example, values of p^{(m1)}, a^{(m1)}, and t^{(m1)} can be set to 0 in step S131. However, the initial values of p^{(m1)}, a^{(m1)}, and t^{(m1)} are not limited. Next, each of the calculation nodes initializes the first variable xᵢ^{(m1)} and the second variable yᵢ^{(m1)} (step S153). Here, the first variable xᵢ^{(m1)} is an element of the first vector. The second variable yᵢ^{(m1)} is an element of the second vector. In step S153, the calculation server may initialize xᵢ^{(m1)} and yᵢ^{(m1)} using pseudorandom numbers, for example. However, a method for initializing xᵢ^{(m1)} and yᵢ^{(m1)} is not limited.

Then, each of the calculation nodes updates the first vector by performing weighted addition on the second variable yᵢ^{(m1)} corresponding to the first variable xᵢ^{(m1)} (step S154). For example, Δt×D×yᵢ^{(m1)} can be added to xᵢ^{(m1)} in step S154. Next, each of the calculation nodes updates the second variable yᵢ^{(m1)} (steps S155 to S157). For example, Δt×[(p−D−K×xᵢ^{(m1)}×xᵢ^{(m1)})×xᵢ^{(m1)}] can be added to yᵢ^{(m1)} in step S155. In step S156, −Δt×c×hᵢ×a−Δt×c×ΣJᵢⱼ×xⱼ^{(m1)} can be further added to yᵢ^{(m1)}. Step S156 corresponds to a process of adding the problem term to the second variable yᵢ. Then, the correction term of (19) can be added to the second variable yᵢ in step S157. Each of the calculation nodes calculates the correction term based on, for example, the first vector and the searched vector stored in a shared storage area 300. Here, the searched vector may be stored by a calculation node that calculates a different solution vector. In addition, the searched vector may be stored by a calculation node that calculates the same solution vector.

Next, each of the calculation nodes updates the values of t^{(m1)}, p^{(m1)}, and a^{(m1)} (step S158). For example, Δt can be added to t^{(m1)}, a constant value (Δp) can be added to p^{(m1)}, and a^{(m1)} may be set to a positive square root of the updated coefficient p. However, this is merely an example of a method for updating the values of p^{(m1)}, a^{(m1)}, and t^{(m1)}. Then, each of the calculation nodes stores a snapshot of the first vector in the storage area 300 (step S159). Here, the snapshot refers to data including a value of each element xᵢ^{(m1)} of the first vector at the timing when step S159 is executed. As the storage area 300, a storage area accessible from the plurality of calculation nodes can be used. In addition, for example, a storage area in the shared memory 32, the storage 34, or an external storage can be used as the storage area 300. However, a type of memory or storage that provides the storage area 300 is not limited. The storage area 300 may be a combination of a plurality of types of memories or storages. Note that the second vector updated to the same iteration as the first vector in step S159 may be stored in the storage area 300.

Next, each of the calculation nodes determines whether the number of updates of the first vector and the second vector is smaller than a threshold (step S160). For example, the determination in step S160 can be performed by comparing the value of the variable t^{(m1)} with T. However, the determination may be performed by other methods.

When the number of update times is smaller than the threshold (YES in step S160), the calculation node executes the processes of step S154 and the subsequent steps. When the number of updates is equal to or larger than the threshold (NO in step S160), the calculation server increments the counter variable m1 (step S161). Note that step S161 may be skipped. Then, the calculation server or the management server 1 can select at least one of searched vectors stored in the storage area 300 based on a value of a Hamiltonian and calculate a solution vector (step S162). The Hamiltonian may be the Hamiltonian in (15) or an objective function including the correction term of (17). In addition, both the former and the latter may be calculated. Note that the value of the Hamiltonian may be calculated at a timing different from step S162. In that case, the calculation node can store the value of the Hamiltonian together with the first vector and the second vector in the storage area 300.

Note that it is not always necessary to store the snapshot of the variable in the storage area 300 every time in step S159. For example, the snapshot of the variable may be stored in the storage area 300 at some times of loop processing of steps S154 to S159. As a result, consumption of the storage area can be suppressed.

In a case where a failure occurs in any of the calculation nodes and a calculation process abnormally stops, it is possible to recover data using the snapshots of the first vector and the second vector stored in the storage area 300 and resume the calculation process. Storing the data of the first vector and the second vector in the storage area 300 contributes to improvement of failure resistance and availability of the information processing system.

Since the storage area 300 in which the plurality of calculation nodes can store the element of the first vector (and the element of the second vector) at an arbitrary timing is prepared in the information processing system, each of the calculation nodes can calculate the correction term of (19) and add the correction term to the variable yᵢ in step S157 regardless of the timing. In the calculation of the correction term of (19), the first vectors calculated in different iterations of the loop processing may be mixed. Therefore, when a certain calculation node is in the middle of updating the first vector, the other calculation node can calculate the correction term using the first vector before the update. As a result, it is possible to efficiently solve a combinatorial optimization problem in a relatively short time while reducing the frequency of synchronization processing of processes among the plurality of calculation nodes.

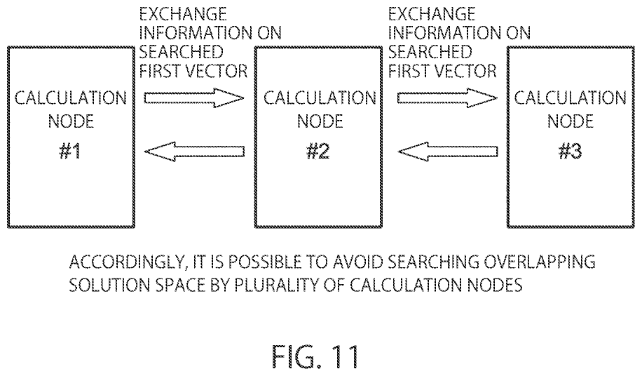

FIG. 11 conceptually illustrates an example of the information processing system including the plurality of calculation nodes. FIG. 11 illustrates a calculation node #1, a calculation node #2, and a calculation node #3. Information on searched first vectors is exchanged between the calculation node #1 and the calculation node #2. Similarly, information on searched first vectors is exchanged between the calculation node #2 and the calculation node #3. Note that information on searched first vectors may be exchanged between the calculation node #1 and the calculation node #3 although not illustrated. Data transfer between the calculation node #1 and the calculation node #3 may be performed directly or indirectly via the calculation node #2. As a result, it is possible to avoid performing the search of the overlapping solution space in the plurality of calculation nodes.

FIG. 11 illustrates the three calculation nodes. However, the number of calculation nodes included in the information processing device or the information processing system may be different from this. In addition, the connection topology between calculation nodes and a path on which data transfer is performed between the calculation nodes are not limited. For example, in a case where the calculation node is a processor, data transfer may be performed through inter-processor communication or the shared memory 32. In addition, in a case where the calculation node is a calculation server, data transfer may be performed via an interconnection between the calculation servers including the switch 5. Note that the respective calculation nodes in FIG. 11 may execute the process of storing the snapshot of the first vector in the storage area 300 described in the flowcharts in FIGS. 9 and 10 in parallel.

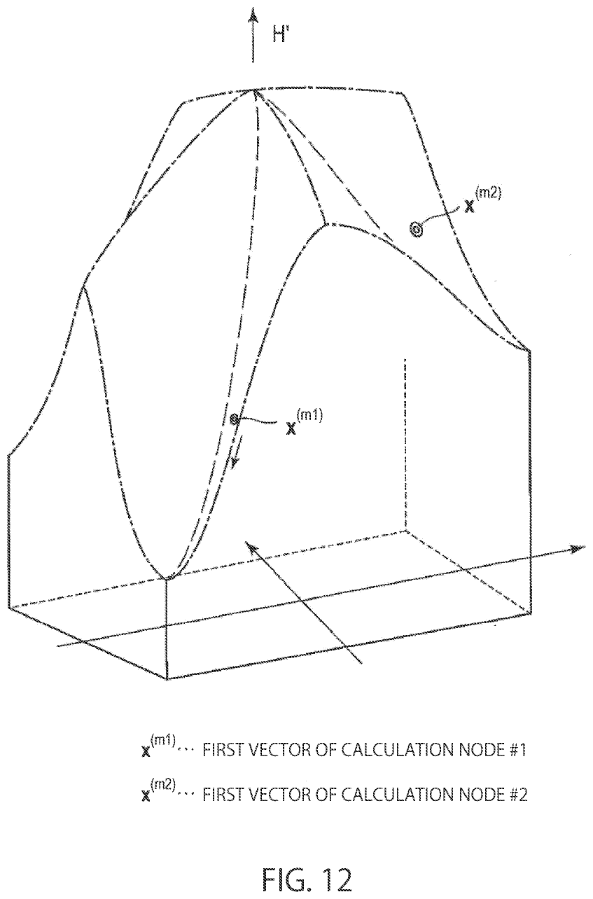

FIGS. 12 to 14 conceptually illustrate examples of changes in a value of an extended Hamiltonian at each of the calculation nodes. FIG. 12 illustrates a first vector x^{(m1)} calculated by the calculation node #1, a first vector x^{(m2)} calculated by the calculation node #2, and a value of an extended Hamiltonian H′.

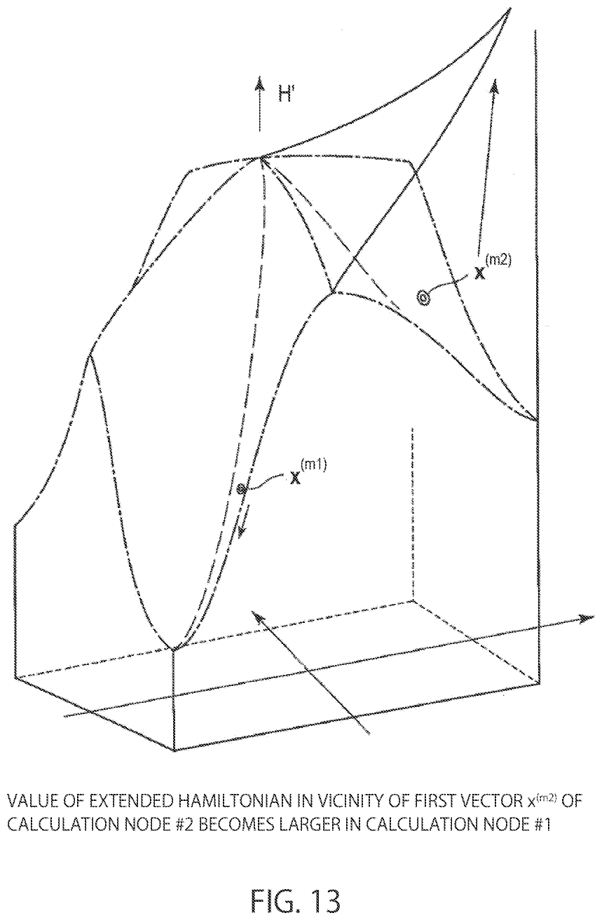

For example, it is assumed that the calculation node #1 acquires data of the first vector x^{(m2)} from the calculation node #2. In this case, the calculation node #1 can calculate the correction term of (19) using the obtained first vector x^{(m2)} and update the first vector and the second vector. As a result, the value of the extended Hamiltonian increases in the vicinity of the first vector x^{(m2)} of the calculation node #2 in the calculation node #1 as illustrated in FIG. 13. This increases the probability that the first vector x^{(m1)} updated at the calculation node #1 is directed to a region farther away from the first vector x^{(m2)} of the calculation node #2 in the solution space.

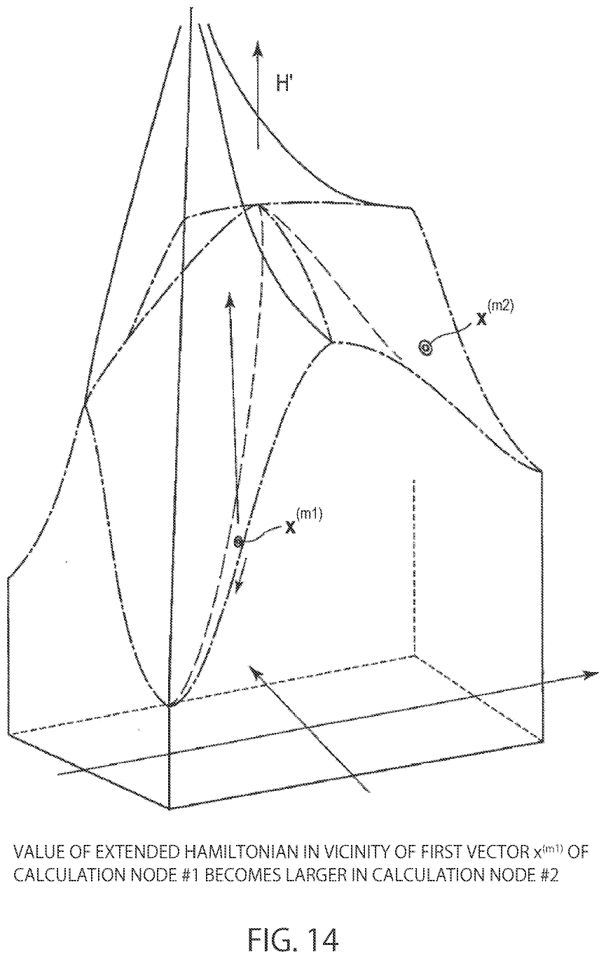

In addition, it is assumed that the calculation node #2 acquires data of the first vector x^{(m1)} from the calculation node #1. In this case, the calculation node #2 can calculate the correction term of (19) using the obtained first vector x^{(m1)} and update the first vector and the second vector. As a result, the value of the extended Hamiltonian increases in the vicinity of the first vector x^{(m1)} of the calculation node #1 in the calculation node #2 as illustrated in FIG. 14. This increases the probability that the first vector x^{(m2)} updated at the calculation node #2 is directed to a region farther away from the first vector x^{(m1)} of the calculation node #1 in the solution space.

As described above, it is possible to avoid the search of the overlapping region of the solution space in the plurality of calculation nodes by adjusting the value of the extended Hamiltonian according to an update situation of the first vector in each of the calculation nodes. Therefore, it is possible to efficiently search for the solution of the combinatorial optimization problem.

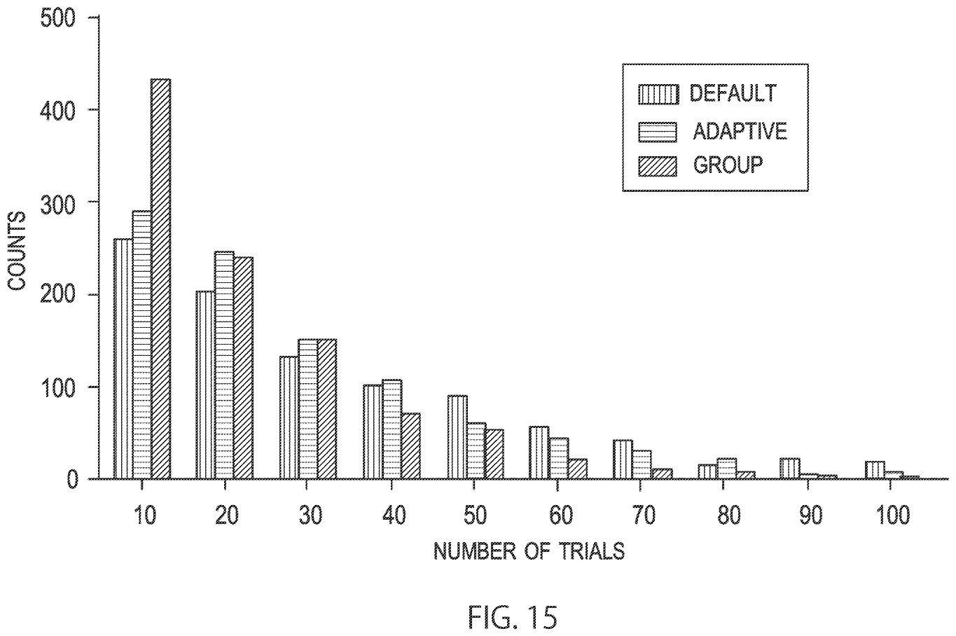

A histogram in FIG. 15 illustrates the number of calculations required to obtain an optimal solution in a plurality of calculation methods. In FIG. 15, data in a case where the Hamiltonian path problem of 48 nodes and 96 edges has been solved is used. The vertical axis in FIG. 15 represents the frequency at which an optimal solution is obtained. On the other hand, the horizontal axis in FIG. 15 represents the number of trials. In FIG. 15, “DEFAULT” corresponds to a result in a case where the processing of the flowchart in FIG. 6 is executed using the Hamiltonian of Formula (3). In addition, “ADAPTIVE” corresponds to a result in a case where the processing of the flowchart in FIG. 8 is executed using the extended Hamiltonian of Formula (10). Further, “GROUP” corresponds to a result in a case where the processing of the flowcharts of FIGS. 9 and 10 is executed using the extended Hamiltonian of Formula (10).

The vertical axis in FIG. 15 represents the frequency at which the optimal solution is obtained within a predetermined number of calculations when 1000 sets of combinations of different matrices Jᵢⱼ and vectors hᵢ are prepared. In the case of “DEFAULT”, the number of calculations corresponds to the number of executions of the processing of the flowchart of FIG. 6. On the other hand, in the cases of “ADAPTIVE” and “GROUP”, the number of calculations corresponds to the number M of searched vectors in Formula (10). In the example of FIG. 15, it can be said that the optimal solution is obtained with the smaller number of calculations as the frequency on the left side of the horizontal axis is higher. For example, in the case of “DEFAULT”, the frequency at which the optimal solution is obtained with the number of calculations of ten times or less is about 260. On the other hand, in the case of “ADAPTIVE”, the frequency at which the optimal solution is obtained with the number of calculations of ten times or less is about 280. Further, in the case of “GROUP”, the frequency at which the optimal solution is obtained with the number of calculations of ten times or less is about 430. Therefore, in the case of the condition of “GROUP”, the probability that the optimal solution can be obtained with the smaller number of calculations is higher as compared with the other cases.

In the information processing device and the information processing system according to the present embodiment, it is possible to avoid the search of the overlapping region in the solution space based on data regarding the searched vector. Therefore, it is possible to search for the solution in the wider region of the solution space and to increase the probability of obtaining the optimal solution or the approximate solution close thereto. In addition, it is easy to parallelize the processes in the information processing device and the information processing system according to the present embodiment, and accordingly, it is possible to more efficiently execute the calculation process. As a result, it is possible to provide the user with the information processing device or the information processing system that calculates the solution of the combinatorial optimization problem within a practical time.

### [Calculation Including Term of Many-Body Interaction]

It is also possible to solve a combinatorial optimization problem having a third-order or higher-order objective function by using the simulated bifurcation algorithm. A problem of obtaining a combination of variables that minimizes the third-order or higher-order objective function, which has a binary variable as a variable, is called a higher-order binary optimization (HOBO) problem. In a case of handling the HOBO problem, the following Formula (21) can be used as an energy formula in an Ising model extended to the higher order.

$$\begin{matrix} [ Formula 21 ] & \\ {E}_{HOBO} = {\sum }_{i = 1}^{N} {J}_{i}^{( 1 )} {s}_{i} + \frac{1}{2} {\sum }_{i = 1}^{N} {\sum }_{j = 1}^{N} {J}_{i , j}^{( 2 )} {s}_{i} {s}_{j} + \frac{1}{3 !} {\sum }_{i = 1}^{N} {\sum }_{j = 1}^{N} {\sum }_{k = 1}^{N} {J}_{i , j , k}^{( 3 )} {s}_{i} {s}_{j} {s}_{k} + … & ( 21 )\end{matrix}$$

Here, J⁽ⁿ⁾ is an n-rank tensor, and is obtained by generalizing the matrix J of the local magnetic field hᵢ and a coupling coefficient of Formula (1). For example, a tensor J corresponds to a vector of the local magnetic field hᵢ. In the n-rank tensors J⁽ⁿ⁾, when a plurality of indices have the same value, values of elements are 0. Although terms up to a third-order term are illustrated in Formula (21), but a higher-order term can also be defined in the same manner as in Formula (21). Formula (21) corresponds to the energy of the Ising model including a many-body interaction.

Note that both QUBO and HOBO can be said to be a type of polynomial unconstrained binary optimization (PUBO). That is, a combinatorial optimization problem having a second-order objective function in PUBO is QUBO. In addition, it can be said that a combinatorial optimization problem having a third-order or higher-order objective function in PUBO is HOBO.

In a case where the HOBO problem is solved using the simulated bifurcation algorithm, the Hamiltonian H of Formula (3) described above may be replaced with the Hamiltonian H of the following Formula (22).

$$\begin{matrix} [ Formula 22 ] & \\ H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + c ( {J}_{i}^{( 1 )} {x}_{i} α ( t ) + \frac{1}{2} {\sum }_{j = 1}^{N} {J}_{i , j}^{( 2 )} {x}_{i} {x}_{j} + \frac{1}{3 !} {\sum }_{j = 1}^{N} {\sum }_{k = 1}^{N} {J}_{i , j , k}^{( 3 )} {x}_{i} {x}_{j} {x}_{k} + … ) ] \\ {H}_{Ising} = {\sum }_{i = 1}^{N} [ {J}_{i}^{( 1 )} {x}_{i} α ( t ) + \frac{1}{2} {\sum }_{j = 1}^{N} {J}_{i , j}^{( 2 )} {x}_{i} {x}_{j} + \frac{1}{3 !} {\sum }_{j = 1}^{N} {\sum }_{k = 1}^{N} {J}_{i , j , k}^{( 3 )} {x}_{i} {x}_{j} {x}_{k} + … ] & ( 22 )\end{matrix}$$

In addition, a problem term is derived from Formula (22) using a plurality of first variables expressed in the following Formula (23).

$$\begin{matrix}[ Formula 23 ] & \\ {z}_{i} = \frac{\partial {H}_{Ising}}{\partial {x}_{i}} = {J}_{i}^{( 1 )} α ( t ) + {\sum }_{j = 1}^{N} {J}_{i , j}^{( 2 )} {x}_{j} + {\sum }_{j = 1}^{N} {\sum }_{k = 1}^{N} {J}_{i , j , k}^{( 3 )} {x}_{j} {x}_{k} + … & ( 23 )\end{matrix}$$

The problem term zᵢ of (23) takes a format in which the second expression of (22) is partially differentiated with respect to any variable xᵢ (element of the first vector). The partially differentiated variable xᵢ differs depending on an index i. Here, the index i of the variable xᵢ corresponds to an index designating an element of the first vector and an element of the second vector.

In a case where calculation including the term of the many-body interaction is performed, the recurrence formula of (20) described above is replaced with the following recurrence formula of (24).

$$\begin{matrix} [ Formula 24 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) - {Kx}_{i}^{2} \} {x}_{i} ( t + Δ t ) ] Δ t - c Δ t ( {J}_{i}^{( 1 )} α ( t + Δ t ) + {\sum }_{j = 1}^{N} {J}_{i , j}^{( 2 )} {x}_{j} ( t + Δ t ) + {\sum }_{j = 1}^{N} {\sum }_{k = 1}^{N} {J}_{i , j , k}^{( 3 )} {x}_{j} ( t + Δ t ) {x}_{k} ( t + Δ t ) + … ) + {k}_{G} {c}_{G} {\sum }_{m = 1}^{M} \frac{{x}^{( m 1 )} ( t + Δ t ) - {x}^{( m 2 )}}{{‖ {x}^{( m 1 )} ( t + Δ t ) - {x}^{( m 2 )} ‖}^{{k}_{G} + 2}} & ( 24 )\end{matrix}$$

(24) corresponds to a further generalized recurrence formula of (20). Similarly, the term of the many-body interaction may be used in the recurrence formula of (13) described above.

The problem terms described above are merely examples of a problem term that can be used by the information processing device according to the present embodiment. Therefore, a format of the problem term used in the calculation may be different from these.

### [Modified Example of Algorithm]

Here, a modified example of the simulated bifurcation algorithm will be described. For example, various modifications may be made to the above-described simulated bifurcation algorithm for the purpose of reducing an error or reducing a calculation time.

For example, additional processing may be executed at the time of updating a first variable in order to reduce the error in calculation. For example, when an absolute value of the first variable xᵢ becomes larger than 1 by the update, the value of the first variable xᵢ is replaced with sgn(xᵢ). That is, when xᵢ>1 is satisfied by the update, the value of the variable xᵢ is set to 1. In addition, when xᵢ<−1 is satisfied by the update, the value of the variable xᵢ is set to −1. As a result, it is possible to approximate the spin sᵢ with higher accuracy using the variable xᵢ. Since such processing is included, the algorithm is equivalent to a physical model of an N particles having a wall at positions of xᵢ=+1. More generally speaking, an arithmetic circuit may be configured to set the first variable, which has a value smaller than a second value, to the second value, and set the first variable, which has a value larger than a first value, to the first value.

Further, when xᵢ>1 is satisfied by the update, the variable yᵢ corresponding to the variable xᵢ may be multiplied by a coefficient rf. For example, when the coefficient rf of −1<r≤0 is used, the above wall becomes a wall of the reflection coefficient rf. In particular, when the coefficient rf of rf=0 is used, the algorithm is equivalent to a physics model with a wall causing completely inelastic collisions at positions of xᵢ=±1. More generally speaking, the arithmetic circuit may be configured to update a second variable which corresponds to the first variable having the value smaller than the first value or a second variable which corresponds to the first variable larger than the second value, to a value obtained by multiplying the original second variable by a second coefficient. For example, the arithmetic circuit may be configured to update the second variable which corresponds to the first variable having the value smaller than −1 or the second variable which corresponds to the first variable having the value larger than 1, to the value obtained by multiplying the original second variable by the second coefficient. Here, the second coefficient corresponds to the above-described coefficient rf.

Note that the arithmetic circuit may set a value of the variable yᵢ corresponding to the variable xᵢ to a pseudo random number when xᵢ>1 is satisfied by the update. For example, a random number in the range of [−0.1, 0.1] can be used. That is, the arithmetic circuit may be configured to set a value of the second variable which corresponds to a first variable having the value smaller than the second value or a value of the second variable which corresponds to the first variable having the value larger than the first value, to the pseudo random number.

If the update process is executed so as to suppress |xᵢ|>1 as described above, the value of xᵢ does not diverge even if the non-linear term K×xᵢ² in (13), (20), and (24) is removed. Therefore, it is possible to use an algorithm illustrated in (25) below.

$$\begin{matrix} [ Formula 25 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) \} {x}_{i} ( t + Δ t ) ] Δ t - c Δ t ( {J}_{i}^{( 1 )} α ( t + Δ t ) + {\sum }_{j = 1}^{N} {J}_{i , j}^{( 2 )} {x}_{j} ( t + Δ t ) + {\sum }_{j = 1}^{N} {\sum }_{k = 1}^{N} {J}_{i , j , k}^{( 3 )} {x}_{j} ( t + Δ t ) {x}_{k} ( t + Δ t ) + … ) + {k}_{G} {c}_{G} {\sum }_{m = 1}^{M} \frac{{x}^{( m 1 )} ( t + Δ t ) - {x}^{( m 2 )}}{{‖ {x}^{( m 1 )} ( t + Δ t ) - {x}^{( m 2 )} ‖}^{{k}_{G} + 2}} & ( 25 )\end{matrix}$$

In the algorithm of (25), a continuous variable x is used in the problem term instead of a discrete variable. Therefore, there is a possibility that an error from the discrete variable used in the original combinatorial optimization problem occurs. In order to reduce this error, a value sgn(x) obtained by converting the continuous variable x by a signum function can be used instead of the continuous variable x in the calculation of the problem term as in (26) below.

$$\begin{matrix} [ Formula 26 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) \} {x}_{i} ( t + Δ t ) ] Δ t - c Δ t ( {J}_{i}^{( 1 )} α ( t + Δ t ) + {\sum }_{j = 1}^{N} {J}_{i , j}^{( 2 )} sgn ( {x}_{j} ( t + Δ t ) ) + {\sum }_{j = 1}^{N} {\sum }_{k = 1}^{N} {J}_{i , j , k}^{( 3 )} sgn ( {x}_{j} ( t + Δ t ) ) sgn ( {x}_{k} ( t + Δ t ) ) + … ) + {k}_{G} {c}_{G} {\sum }_{m = 1}^{M} \frac{{x}^{( m 1 )} ( t + Δ t ) - {x}^{( m 2 )}}{{‖ {x}^{( m 1 )} ( t + Δ t ) - {x}^{( m 2 )} ‖}^{{k}_{G} + 2}} & ( 26 )\end{matrix}$$

In (26), sgn(x) corresponds to the spin s.

In (26), the coefficient a of a term including the first-rank tensor in the problem term may be a constant (for example, a=1). In an algorithm of (26), the product of spins appearing in the problem term always takes any value of −1 or 1, and thus, it is possible to prevent the occurrence of an error due to the product operation when the HOMO problem having the higher-order objective function is handled. As in the algorithm of (26) described above, data calculated by the calculation server may further include a spin vector (s₁, s₂, . . . , s_{N}) having the variable sᵢ (i=1, 2, . . . , N) as an element. The spin vector can be obtained by converting each element of the first vector by a signum function.

### [Example of Parallelization of Variable Update Processes]

Hereinafter, an example of parallelization of variable update processes at the time of calculation of the simulated bifurcation algorithm will be described.

First, an example in which the simulated bifurcation algorithm is implemented in a PC cluster will be described. The PC cluster is a system that connects a plurality of computers and realizes calculation performance that is not obtainable by one computer. For example, the information processing system 100 illustrated in FIG. 1 includes a plurality of calculation servers and processors, and can be used as the PC cluster. For example, the parallel calculation can be executed even in a configuration in which memories are arranged to be distributed in a plurality of calculation servers as in the information processing system 100 by using a message passing interface (MPI) in the PC cluster. For example, the control program 14E of the management server 1, the calculation program 34B and the control program 34C of each of the calculation servers can be implemented using the MPI.

In a case where the number of processors used in the PC cluster is Q, it is possible to cause each of the processors to calculate L variables among the variables xᵢ included in the first vector (x₁, x₂, . . . , x_{N}). Similarly, it is possible to cause each of the processors to calculate L variables among the variables yᵢ included in the second vector (y₁, y₂, . . . , y_{N}). That is, processors #j (j=1, 2, . . . , Q) calculate variables {xₘ|m=(j−1)L+1, (j−1)L+2, . . . , jL} and {yₘ|m=(j−1)L+1, (j−1)L+2, . . . , jL}. In addition, a tensor J⁽ⁿ⁾ expressed in the following (27), necessary for the calculation of {yₘ|m=(j−1)L+1, (j−1)L+2, . . . , jL} by the processors #j, is stored in a storage area (for example, a register, a cache, a memory, or the like) accessible by the processors #j.

[Formula 27]

{Jₘ⁽¹⁾|m=(i−1)L+1, . . . iL}

{J_{m,j}⁽²⁾|m=(i−1)L+1, . . . iL;j=1, . . . N}

{J_{m,j,k}⁽³⁾|m=(i−1)L+1, . . . iL;j=1, . . . N;k=1, . . . N}, . . . (27)

Here, the case where each of the processors calculates the constant number of variables of each of the first vector and the second vector has been described. However, the number of elements (variables) of each of the first vector and the second vector to be calculated may be different depending on a processor. For example, in a case where there is a performance difference depending on a processor implemented in a calculation server, the number of variables to be calculated can be determined depending on the performance of the processor.

Values of all the components of the first vector (x₁, x₂, . . . , x_{N}) are required in order to update the value of the variable yᵢ. The conversion into a binary variable can be performed, for example, by using the signum function sgn( ). Therefore, the values of all the components of the first vector (x₁, x₂, . . . , x_{N}) can be shared by the Q processors using the Allgather function. Although it is necessary to share the values between the processors regarding the first vector (x₁, x₂, . . . , x_{N}), but it is not essential to share values between the processors regarding the second vector (y₁, y₂, . . . , y_{N}) and the tensor J⁽ⁿ⁾. The sharing of data between the processors can be realized, for example, by using inter-processor communication or by storing data in a shared memory.

The processor #j calculates a value of the problem term {zₘ|m=(j−1)L+1, (j−1)L+2, . . . , jL}. Then, the processor #j updates the variable {yₘ|m=(j−1)L+1, (j−1)L+2, . . . , jL} based on the calculated value of the problem term {{zₘ|m=(j−1)L+1, (j−1)L+2, . . . , jL}.

As illustrated in the above-described respective formulas, the calculation of the vector (z₁, z₂, . . . , z_{N}) of the problem term requires the product-sum operation including the calculation of the product of the tensor J(n) and the vector (x₁, x₂, . . . , x_{N}). The product-sum operation is processing with the largest calculation amount in the above-described algorithm, and can be a bottleneck in improving the calculation speed. Therefore, the product-sum operation is distributed to Q=N/L processors and executed in parallel in the implementation of the PC cluster, so that the calculation time can be shortened.

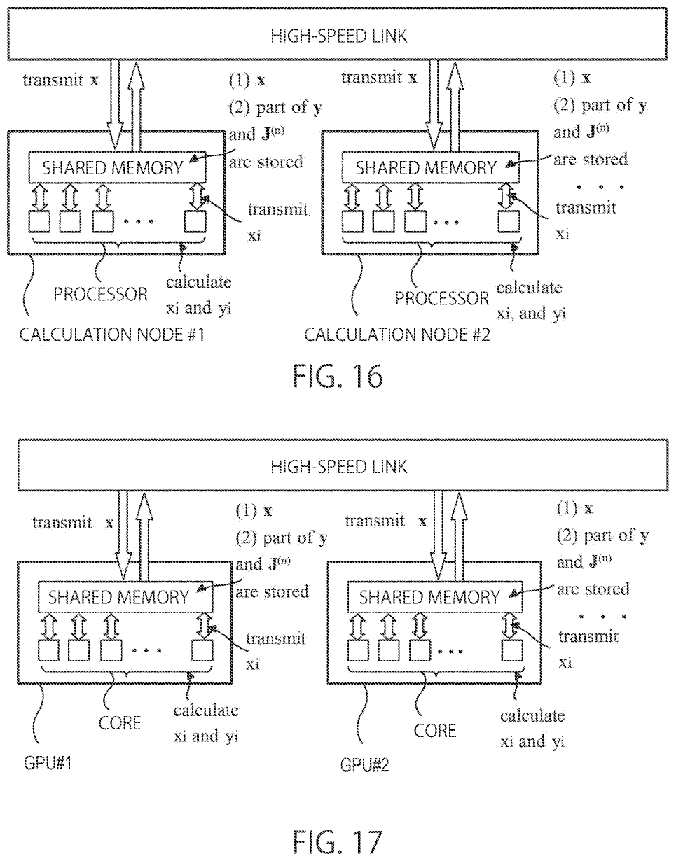

FIG. 16 schematically illustrates an example of a multi-processor configuration. A plurality of calculation nodes in FIG. 16 correspond to, for example, the plurality of calculation servers of the information processing system 100. In addition, a high-speed link of FIG. 16 corresponds to, for example, the interconnection between the calculation servers formed by the cables 4a to 4c and the switch 5 of the information processing system 100. A shared memory in FIG. 16 corresponds to, for example, the shared memory 32. Processors in FIG. 16 correspond to, for example, the processors 33A to 33D of the respective calculation servers. Note that FIG. 16 illustrates the plurality of calculation nodes, but the use of a configuration of a single calculation node is not precluded.

FIG. 16 illustrates data arranged in each of components and data transferred between the components. In each of the processors, values of the variables xᵢ and yᵢ are calculated. In addition, the variable xᵢ is transferred between the processor and the shared memory. In the shared memory of each of the calculation nodes, for example, the first vector (x₁, x₂, . . . , x_{N})), L variables of the second vector (y₁, y₂, . . . , y_{N}), and some of the tensors J⁽ⁿ⁾ are stored. Then, for example, the first vector (x₁, x₂, . . . , x_{N}) is transferred in the high-speed link connecting the calculation nodes. In a case where the Allgather function is used, all elements of the first vector (x₁, x₂, . . . , x_{N}) are required in order to update the variable yᵢ in each of the processors.

Note that the arrangement and transfer of data illustrated in FIG. 16 are merely examples. A data arrangement method, a transfer method, and a parallelization method in the PC cluster are not particularly limited.

In addition, the simulated bifurcation algorithm may be calculated using a graphics processing unit (GPU).

FIG. 17 schematically illustrates an example of a configuration using the GPU. FIG. 17 illustrates a plurality of GPUs connected to each other by a high-speed link. Each GPU is equipped with a plurality of cores capable of accessing a shared memory. In addition, the plurality of GPUs are connected via the high-speed link to form a GPU cluster in the configuration example of FIG. 17. For example, if the GPUs are mounted on the respective calculation servers in FIG. 1, the high-speed link corresponds to the interconnection between the calculation servers formed by the cables 4a to 4c and the switch 5. Note that the plurality of GPUs are used in the configuration example of FIG. 17, but parallel calculation can be executed even in a case where one GPU is used. That is, each of the GPUs of FIG. 17 may perform the calculation corresponding to each of the calculation nodes of FIG. 16. That is, the processor (processing circuit) of the information processing device (calculation server) may be a core of the graphics processing unit (GPU).

In the GPU, the variables xᵢ and yᵢ and the tensor J⁽ⁿ⁾ are defined as device variables. The GPUs can calculate the product of the tensor J⁽ⁿ⁾ necessary to update the variable yᵢ and the first vector (x₁, x₂, . . . , x_{N}) in parallel by a matrix vector product function. Note that the product of the tensor and the vector can be obtained by repeatedly executing the matrix vector product operation. In addition, it is possible to parallelize the processes by causing each thread to execute a process of updating the i-th element (xᵢ, yᵢ) for a portion other than the product-sum operation in the calculation of the first vector (x₁, x₂, . . . , x_{N}) and the second vector (y₁, y₂, . . . , y_{N}).

### [Overall Processing for Solving Combinatorial Optimization Problem]

The following describes overall processing executed to solve a combinatorial optimization problem using the simulated bifurcation algorithm.

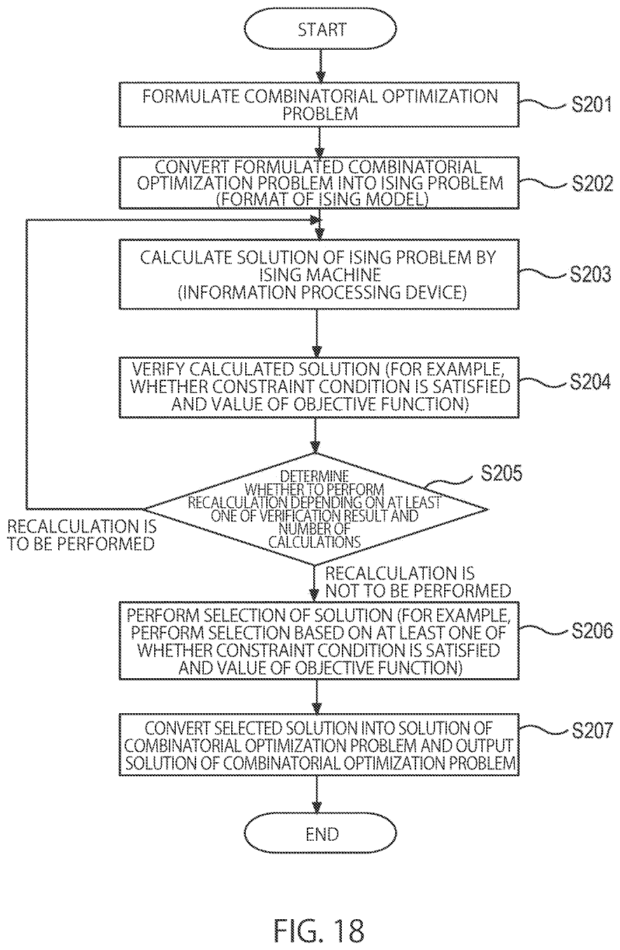

A flowchart of FIG. 18 illustrates an example of the overall processing executed to solve the combinatorial optimization problem. Hereinafter, the processing will be described with reference to FIG. 18.

First, the combinatorial optimization problem is formulated (step S201). Then, the formulated combinatorial optimization problem is converted into an Ising problem (a format of an Ising model) (step S202). Next, a solution of the Ising problem is calculated by an Ising machine (information processing device) (step S203). Then, the calculated solution is verified (step S204). For example, in step S204, whether a constraint condition has been satisfied is confirmed. In addition, whether the obtained solution is an optimal solution or an approximate solution close thereto may be confirmed by referring to a value of an objective function in step S204.

Then, it is determined whether recalculation is to be performed depending on at least one of the verification result or the number of calculations in step S204 (step S205). When it is determined that the recalculation is to be performed (YES in step S205), the processes in steps S203 and S204 are executed again. On the other hand, when it is determined that the recalculation is not to be performed (NO in step S205), a solution is selected (step S206). For example, in step S206, the selection can be performed based on at least one of whether the constraint condition is satisfied or the value of the objective function. Note that the process of step S206 may be skipped when a plurality of solutions are not calculated. Finally, the selected solution is converted into a solution of the combinatorial optimization problem, and the solution of the combinatorial optimization problem is output (step S207).

When the information processing device, the information processing system, the information processing method, the storage medium, and the program described above are used, the solution of the combinatorial optimization problem can be calculated within the practical time. As a result, it becomes easier to solve the combinatorial optimization problem, and it is possible to promote social innovation and progress in science and technology.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing device configured to repeatedly update a first vector, which has a first variable as an element, and a second vector, which has a second variable corresponding to the first variable as an element, the information processing device comprising:
a storage unit; and
a processing circuit configured to update the first vector by weighted addition of the corresponding second variable to the first variable,
store the updated first vector in the storage unit as a searched vector, and
perform weighting of the first variable with a first coefficient that monotonically increases or monotonically decreases depending on a number of updates and add the weighted first variable to the corresponding second variable, calculate a problem term using a plurality of the first variables, add the problem term to the second variable, read the searched vector from the storage unit, calculate a correction term including an inverse number of a distance between the first vector to be updated and the searched vector, and add the correction term to the second variable to update the second vector.

2. The information processing device according to claim 1, wherein
the processing circuit is configured to calculate the inverse number of the distance using each of a plurality of the searched vectors, and add a plurality of the inverse numbers to calculate the correction term.

3. The information processing device according to claim 1, comprising
a plurality of the processing circuits,
wherein each of the processing circuits is configured to read the searched vector stored in the storage unit by the other processing circuit.

4. The information processing device according to claim 3, wherein
the plurality of processing circuits are divided into a plurality of groups, each of the groups executing a process of updating different pairs of the first vector and the second vector.

5. The information processing device according to claim 1, comprising
a plurality of the processing circuits,
wherein each of the processing circuits is configured to transfer the updated first vector to the other processing circuit, and calculate the correction term using the first vector received from the other processing circuit instead of the searched vector.

6. The information processing device according to claim 1, wherein
the processing circuit is configured to store the updated second vector as a third vector in the storage unit.

7. The information processing device according to claim 6, wherein
the processing circuit is configured to read the third vector updated to a same iteration as the searched vector from the storage unit, and calculate a value of an objective function based on the searched vector and the third vector.

8. The information processing device according to claim 7, wherein
the processing circuit is configured to determine whether to stop updating the first vector and the second vector based on the value of the objective function.

9. The information processing device according to claim 8, wherein
the processing circuit is configured to select one of the searched vectors from the plurality of searched vectors stored in the storage unit based on the value of the objective function, and calculate a solution vector by converting the first variable, which is a positive value of the selected searched vector, into a first value and converting the first variable, which is a negative value, into a second value smaller than the first value.

10. The information processing device according to claim 1, wherein
the problem term calculated by the processing circuit is based on an Ising model.

11. The information processing device according to claim 10, wherein
the problem term calculated by the processing circuit includes many-body interaction.

12. An information processing system configured to repeatedly update a first vector, which has a first variable as an element, and a second vector, which has a second variable corresponding to the first variable as an element, the information processing system comprising:
a storage device; and a plurality of information processing devices,
wherein each of the information processing devices is configured to
update the first vector by weighted addition of the corresponding second variable to the first variable,
store the updated first vector in the storage device as a searched vector, and
perform weighting of the first variable with a first coefficient that monotonically increases or monotonically decreases depending on a number of updates and add the weighted first variable to the corresponding second variable, calculate a problem term using a plurality of the first variables, add the problem term to the second variable, read the searched vector from the storage device, calculate a correction term including an inverse number of a distance between the first vector to be updated and the searched vector, and add the correction term to the second variable to update the second vector.

13. The information processing system according to claim 12, wherein
the plurality of information processing devices are divided into a plurality of groups, each of the groups executing a process of updating different pairs of the first vector and the second vector.

14. An information processing method for repeatedly updating a first vector, which has a first variable as an element, and a second vector, which has a second variable corresponding to the first variable as an element, by using a storage unit and a plurality of processing circuits, the information processing method comprising:
a step of updating the first vector by weighted addition of the corresponding second variable to the first variable by the plurality of processing circuits;
a step of storing the updated first vector in the storage unit as a searched vector by the plurality of processing circuits;
a step of performing weighting of the first variable with a first coefficient that monotonically increases or monotonically decreases depending on a number of updates and adding the weighted first variable to the corresponding second variable by the plurality of processing circuits;
a step of calculating a problem term using a plurality of the first variables and adding the problem term to the second variable by the plurality of processing circuits;
a step of reading the searched vector from the storage unit by the plurality of processing circuits;
a step of calculating a correction term including an inverse number of a distance between the first vector to be updated and the searched vector by the plurality of processing circuits; and
a step of adding the correction term to the second variable by the plurality of processing circuits.

15. An information processing method for repeatedly updating a first vector, which has a first variable as an element, and a second vector, which has a second variable corresponding to the first variable as an element, by using a storage device and a plurality of information processing devices, the information processing method comprising:
a step of updating the first vector by weighted addition of the corresponding second variable to the first variable by the plurality of information processing devices;
a step of storing the updated first vector in the storage device as a searched vector by the plurality of information processing devices;
a step of performing weighting of the first variable with a first coefficient that monotonically increases or monotonically decreases depending on a number of updates and adding the weighted first variable to the corresponding second variable by the plurality of information processing devices;
a step of calculating a problem term using a plurality of the first variables and adding the problem term to the second variable by the plurality of information processing devices;
a step of reading the searched vector from the storage device by the plurality of information processing devices;
a step of calculating a correction term including an inverse number of a distance between the first vector to be updated and the searched vector by the plurality of information processing devices; and
a step of adding the correction term to the second variable by the plurality of information processing devices.

16. A non-transitory computer-readable storage medium storing a program for repeatedly updating a first vector, which has a first variable as an element, and a second vector, which has a second variable corresponding to the first variable as an element, the program causing a computer to execute:
a step of updating the first vector by weighted addition of the corresponding second variable to the first variable;
a step of storing the updated first vector in a storage unit as a searched vector;
a step of performing weighting of the first variable with a first coefficient that monotonically increases or monotonically decreases depending on a number of updates and adding the weighted first variable to the corresponding second variable;
a step of calculating a problem term using a plurality of the first variables and adding the problem term to the second variable;
a step of reading the searched vector from the storage unit;
a step of calculating a correction term including an inverse number of a distance between the first vector to be updated and the searched vector; and
a step of adding the correction term to the second variable.
